(19) United States
(12) Patent Application Publication
(10) Pub. No.: US 2024/0396003 A1
(43) Pub. Date: Nov. 28, 2024

(54) SYSTEM AND METHOD FOR DRY BATTERY ELECTRODE FABRICATION VIA DIRECT POWDER BED FORMATION AND COMPRESSION

(71) Applicants: Yoon HWA, Chandler, AZ (US); Yuhui AN, Scottsdale, AZ (US)

(72) Inventors: Yoon HWA, Chandler, AZ (US); Yuhui AN, Scottsdale, AZ (US)

(73) Assignee: Arizona Board of Regents on Behalf of Arizona State University, Scottsdale, AZ (US)

(21) Appl. No.: 18/676,295

(22) Filed: May 28, 2024

Related U.S. Application Data
(60) Provisional application No. 63/504,740, filed on May 27, 2023.

(51) Int. Cl. H01M 4/04

(52) U.S. Cl. CPC H01M 4/0435; H01M 4/0404; H01M 4/0416

(57) ABSTRACT

A system and method for the solvent-free fabrication of a battery electrode is disclosed. The method includes forming a dry powder bed on top of a current collector by dispensing an electrode powder directly onto the current collector as a dry powder bed. The method also includes compressing the dry powder bed and the current collector together using a heat-roll press, resulting in an electrode film adhered to the current collector forming the battery electrode. Dispensing the electrode powder may include using a powder dispensing unit having a powder supply sieve suspended within an outer frame by springs and holding the electrode powder, as well as vibrating the powder supply sieve such that the electrode powder passes through the powder supply sieve. The powder supply sieve may have a mesh size such that the sieve holds the electrode powder when the powder supply sieve is motionless.

### RELATED APPLICATIONS

This application claims the benefit of U.S. provisional patent application 63/504,740, filed May 27, 2023, titled “Method for Dry Battery Electrode Manufacturing via Direct Powder Bed Formation and Compression,” the entirety of the disclosure of which is hereby incorporated by this reference.

### TECHNICAL FIELD

Aspects of this document relate generally to the fabrication of battery electrodes.

### BACKGROUND

As the transportation industry shifts towards electric vehicles in an effort to reduce environmental impact, sustainable battery manufacturing will become critical for the development of a clean-energy economy in the US. Batteries will need improved performance while being less expensive and more environmentally sound to manufacture. The current state-of-the-art method for battery electrode manufacturing will be unable to meet the needs of the future on a number of fronts, including environmental impact, advancing electrode structure, and reduced manufacturing costs.

Lithium-ion battery electrodes typically comprise active materials and conductive additives coated onto a metal foil current collector. In addition to the active materials' intrinsic properties, the microstructure of battery electrodes, as determined by the thickness, porosity, and solid mixture homogeneity, has a large impact on the internal resistance of lithium-ion batteries. This makes the microstructure of the electrodes an important area of focus when striving for optimal battery performance and reliability. The electronic resistance of the electrodes can be driven by the presence of insulating materials and/or poor connectivity between the conductive particles. Ionic resistance given by the flow of ions through the electrolyte within the pores of the electrodes can arise from low porosity or poor pore connectivity. These resistance terms, strongly influenced by the electrode microstructure, can impact the battery's capacity and rate performance. As the thickness of the electrode is increased, loading on more active materials to improve the areal capacity (mAh/cm²), the impact on the resistance becomes more severe. Additionally, the homogeneity of the solid constituent of a battery electrode is an important factor to consider, as poor homogeneity can cause inhomogeneous current distribution and the occurrence of locally uneven faradaic reactions in the electrodes. This is a particularly critical problem for applications such as electric vehicles, where consistent and reliable battery performance is essential.

Currently, a wet slurry casting method is commonly used for electrode manufacturing because it produces uniform electrode microstructures and provides good control over their physical properties. The conventional wet-slurry-based roll-to-roll (R2R) process involves mixing active materials, conductive additives, binders, and solvents to form a slurry, which is then coated onto a metal foil current collector using a doctor blade or slot die coating technique. The coated substrate is then dried and compressed to remove the solvent and form a solid, dense electrode with reliably consistent electrode properties.

This process requires the use of solvents, such as n-methyl-2-pyrrolidone (NMP), to form a polymer binder solution where active materials and carbon additives are uniformly dispersed. This presents a number of problems. The solvents, especially NMP, are toxic and flammable. Their evaporation and recovery requires additional steps while still resulting in substantial waste (e.g., unused slurry). This slurry preparation, casting, and drying process, followed by solvent vapor recovery, is highly energy-intensive and increases the manufacturing costs. It is estimated that up to 15% of the energy costs associated with electrode manufacture is attributed to drying and recovering the NMP. This increases the expense of the R2R process while also making it less environmentally sustainable. Furthermore, the conventional R2R process is inadequate for meeting the rising demand for more complex and customized three-dimensional electrode designs. Alternative and more advanced manufacturing methods are needed to meet the future demands of greener and inexpensive energy storage solutions.

### SUMMARY

According to one aspect, a method for the solvent-free fabrication of a battery electrode includes forming a dry powder bed on top of a current collector that is metallic by dispensing a first electrode powder directly onto the current collector as a first layer. The first electrode powder is solvent-free and the dry powder bed includes an active material. The method also includes compressing the dry powder bed and the current collector together using a heat-roll press, resulting in an electrode film adhered to the current collector that together form the battery electrode.

Particular embodiments may comprise one or more of the following features. Dispensing the first electrode powder may include dispensing the first electrode powder using a first powder dispensing unit having a powder supply sieve suspended within an outer frame by a plurality of springs. The first electrode powder may be placed upon the powder supply sieve, the powder supply sieve having a mesh size such that the powder supply sieve holds the first electrode powder when the powder supply sieve is motionless. Dispensing the first electrode powder using the first powder dispensing unit may include vibrating the powder supply sieve of the first powder dispensing unit such that the first electrode powder passes through the powder supply sieve while the current collector is positioned beneath the first powder dispensing unit. Dispensing the first electrode powder using the first powder dispensing unit may include vibrating the powder supply sieve of the first powder dispensing unit using a transducer. The first electrode powder may include a binder. The first electrode powder may be entirely composed of the active material. Forming the dry powder bed on top of the current collector further may include dispensing a second electrode powder as a second layer directly onto the first layer composed of the first electrode powder. The electrode film may be a multilayered electrode film. The first electrode powder and the second electrode powder may have the same composition. The first electrode powder has a first particle size, and the second electrode powder has a second particle size that may be different from the first particle size. The first electrode powder has a first composition and the second electrode powder has a second composition that may be different from the first composition. Forming the dry powder bed further may include dispensing additional electrode powder layers on top of the first layer such that the dry powder bed includes a plurality of electrode powder layers, each electrode powder layer having a thickness. The plurality of electrode powder layers may include a patterned powder layer with micro-patterned thickness variations. Dispensing the patterned powder layer having the micro-patterned thickness variations may include dispensing said electrode powder layer such that it falls through a patterning screen before becoming part of the dry powder bed. The method may further include recovering the first electrode powder collected on a window frame for reapplication. Forming the dry powder bed may include dispensing the first electrode powder such that the first electrode powder falls through the window frame before falling directly onto the current collector.

According to another aspect, a method for the solvent-free fabrication of a battery electrode includes forming a dry powder bed on top of a current collector that is metallic by dispensing a first electrode powder directly onto the current collector as a first layer, then dispensing a second electrode powder as a second layer directly onto the first layer. The method also includes compressing the dry powder bed and the current collector together using a heat-roll press, resulting in a multilayered electrode film adhered to the current collector that together form the battery electrode. The first electrode powder and the second electrode powder are both solvent-free and the dry powder bed includes an active material and a binder.

Particular embodiments may comprise one or more of the following features. Dispensing the first electrode powder may include dispensing the first electrode powder using a first powder dispensing unit having a powder supply sieve suspended within an outer frame by a plurality of springs, the first electrode powder being placed upon the powder supply sieve. The powder supply sieve may have a mesh size such that the powder supply sieve holds the first electrode powder when the powder supply sieve is motionless. Dispensing the first electrode powder using the first powder dispensing unit may include vibrating the powder supply sieve of the first powder dispensing unit such that the first electrode powder passes through the powder supply sieve while the current collector is positioned beneath the first powder dispensing unit. Dispensing the first electrode powder using the first powder dispensing unit may include vibrating the powder supply sieve of the first powder dispensing unit using a transducer. Forming the dry powder bed further may include dispensing additional electrode powder layers on top of the first layer such that the dry powder bed includes a plurality of electrode powder layers, each electrode powder layer having a thickness. The plurality of electrode powder layers may include a patterned powder layer with micro-patterned thickness variations. Dispensing the patterned powder layer having the micro-patterned thickness variations may include dispensing said electrode powder layer such that it falls through a patterning screen before becoming part of the dry powder bed.

According to yet another aspect, a system for the solvent-free fabrication of a battery electrode includes a first powder dispensing unit positioned above a current collector that is metallic. The first powder dispensing unit is configured to dispense a uniform first layer of a first electrode powder on top of the current collector, the first electrode powder being solvent-free and includes an active material. The system also includes a heat-roll press configured to receive the current collector and compress a dry powder bed and the current collector together to form an electrode film adhered to the current collector that together form the battery electrode, the dry powder bed having been formed on top of the current collector by the first powder dispensing unit dispensing the first electrode powder on top of the current collector as the first layer.

Particular embodiments may comprise one or more of the following features. The first powder dispensing unit may include a powder supply sieve suspended within an outer frame by a plurality of springs. The first electrode powder may be placed upon the powder supply sieve, the powder supply sieve having a mesh size such that the powder supply sieve holds the first electrode powder when the powder supply sieve is motionless. The first powder dispensing unit may further include one of a transducer and a solenoid configured to vibrate the powder supply sieve and cause the first electrode powder to pass through the powder supply sieve and fall on to the current collector below the first powder dispensing unit. The system may further include a patterning screen positioned between the first powder dispensing unit and the current collector such that the first electrode powder uniformly dispensed by the first powder dispensing unit falls through the patterning screen before forming the first layer on top of the current collector, the first layer being a patterned powder layer with micro-patterned thickness variations. The system may further include a window frame positioned between the first powder dispensing unit and the current collector such that the first electrode powder dispensed by the first powder dispensing unit falls through the window frame before falling onto the current collector, the first electrode powder collected on the window frame may be recovered for reapplication.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

The disclosure will hereinafter be described in conjunction with the appended drawings, where like designations denote like elements, and:

FIG. 1A shows a perspective view of a dry fabrication system for battery electrodes having a monolayer electrode film;

FIG. 1B shows a cross-sectional view of the heat-roll press and dry powder bed of the dry fabrication system of FIG. 1A;

FIG. 1C shows a perspective view of a dry fabrication system for battery electrodes comprising a patterned powder layer;

FIG. 1D shows a cross-sectional view of the heat-roll press and dry powder bed of the dry fabrication system of FIG. 1C;

FIG. 1E shows a perspective view of a dry fabrication system for battery electrodes comprising a multilayered electrode film;

FIG. 1F shows a cross-sectional view of the heat-roll press and dry powder bed of the dry fabrication system of FIG. 1E;

FIG. 1G shows a perspective view of a dry fabrication system for battery electrodes comprising a window frame;

FIG. 1H shows a cross-sectional view of the heat-roll press and window frame of the dry fabrication system of FIG. 1G;

FIG. 1I shows a top view of the window frame of the dry fabrication system of FIG. 1G;

FIGS. 2A and 2B show top and side views of a powder dispensing unit;

FIG. 2C shows a side view of another embodiment of a powder dispensing unit;

FIG. 3A shows X-ray diffraction patterns of S-KB nano-composite and Ketjen black;

FIG. 3B shows an SEM image of the S-KB nano-composite;

FIG. 3C shows a TGA result of the S-KB nano-composite;

FIGS. 4A-4D show photos of a cast binder-free dry powder bed and electrodes;

FIGS. 4E and 4F show the top and cross-sectional SEM images of the binder-free S-KB electrode, respectively;

FIGS. 5A-5C show multi-layered dry powder bed configurations for 3D electrode fabrication;

FIG. 6 shows experimental results illustrating the correlation between roll temperature and pressure and the resultant porosity at specific sulfur mass loadings;

FIGS. 7A-7D show SEM images of a dry powder bed of sulfur after being heat pressed at various temperatures;

FIGS. 8A and 8B show voltage profiles of S/KB electrodes prepared by the binder-free dry process and slurry casting process, respectively;

FIGS. 8C and 8D shows voltage profiles and a specific capacity vs. cycle number plot for different rate capabilities of a binder free S/KB nano-composite electrode, respectively;

FIGS. 9A-9D show photos of cast dry powder beds (consisting of LCO, super P and PVDF binder) and electrodes for different structures (planar or patterned); and

FIGS. 10A and 10B show voltage profiles of planar and patterned LCO electrodes, respectively.

### DETAILED DESCRIPTION

This disclosure, its aspects and implementations, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

While this disclosure includes a number of embodiments in many different forms, there is shown in the drawings and will herein be described in detail particular embodiments with the understanding that the present disclosure is to be considered as an exemplification of the principles of the disclosed methods and systems, and is not intended to limit the broad aspect of the disclosed concepts to the embodiments illustrated.

As the transportation industry shifts towards electric vehicles in an effort to reduce environmental impact, sustainable battery manufacturing will become critical for the development of a clean-energy economy in the US. Batteries will need improved performance while being less expensive and more environmentally sound to manufacture. The current state-of-the-art method for battery electrode manufacturing will be unable to meet the needs of the future on a number of fronts, including environmental impact, advancing electrode structure, and reduced manufacturing costs.

Lithium-ion battery electrodes typically comprise active materials and conductive additives coated onto a metal foil current collector. In addition to the active materials' intrinsic properties, the microstructure of battery electrodes, as determined by the thickness, porosity, and solid mixture homogeneity, has a large impact on the internal resistance of lithium-ion batteries. This makes the microstructure of the electrodes an important area of focus when striving for optimal battery performance and reliability. The electronic resistance of the electrodes can be driven by the presence of insulating materials and/or poor connectivity between the conductive particles. Ionic resistance given by the flow of ions through the electrolyte within the pores of the electrodes can arise from low porosity or poor pore connectivity. These resistance terms, strongly influenced by the electrode microstructure, can impact the battery's capacity and rate performance. As the thickness of the electrode is increased, loading on more active materials to improve the areal capacity (mAh/cm²), the impact on the resistance becomes more severe. Additionally, the homogeneity of the solid constituent of a battery electrode is an important factor to consider, as poor homogeneity can cause inhomogeneous current distribution and the occurrence of locally uneven faradaic reactions in the electrodes. This is a particularly critical problem for applications such as electric vehicles, where consistent and reliable battery performance is essential.

Currently, a wet slurry casting method is commonly used for electrode manufacturing because it produces uniform electrode microstructures and provides good control over their physical properties. The conventional wet-slurry-based roll-to-roll (R2R) process involves mixing active materials, conductive additives, binders, and solvents to form a slurry, which is then coated onto a metal foil current collector using a doctor blade or slot die coating technique. The coated substrate is then dried and compressed to remove the solvent and form a solid, dense electrode with reliably consistent electrode properties.

This process requires the use of solvents, such as n-methyl-2-pyrrolidone (NMP), to form a polymer binder solution where active materials and carbon additives are uniformly dispersed. This presents a number of problems. The solvents, especially NMP, are toxic and flammable. Their evaporation and recovery requires additional steps while still resulting in substantial waste (e.g., unused slurry). This slurry preparation, casting, and drying process, followed by solvent vapor recovery, is highly energy-intensive and increases the manufacturing costs. It is estimated that up to 15% of the energy costs associated with electrode manufacture is attributed to drying and recovering the NMP. This increases the expense of the R2R process while also making it less environmentally sustainable. Furthermore, the conventional R2R process is inadequate for meeting the rising demand for more complex and customized three-dimensional electrode designs. Alternative and more advanced manufacturing methods are needed to meet the future demands of greener and inexpensive energy storage solutions.

Contemplated herein is a system and method for dry battery electrode fabrication via direct powder bed formation and compression. This method and system for dry battery electrode fabrication (hereinafter dry fabrication system and dry fabrication method) presents a new, green, and efficient methodology for battery electrode fabrication. According to various embodiments, the dry fabrication method and system comprise two phases: (1) a solvent-free, gravity-assisted powder bed formation phase, and (2) a thermally-assisted powder bed compression and lamination phase, to fabricate conventional 2D or uniquely 3D designed electrodes.

Advantageous over conventional methods, the contemplated method is dry, omitting the need for a solvent and the accompanying environmental and energy costs. According to various embodiments, the system and method contemplated herein can be implemented with just the essential electrode materials (active material, carbon or other conductive additive, and binder) with practical weight fraction of over 90 wt. % for the active material. In some embodiments, the binder may also be omitted. The unused powder is easy to collect, which enables zero-waste manufacturing. Furthermore, the contemplated manufacturing process can create electrodes with 3D engineered porosity and structure that could potentially boost battery performance beyond what is achievable with conventional 2D structured electrodes.

The development of processes for manufacturing electrodes without binders or solvents presents a number of benefits to the field of rechargeable batteries. The absence of binders in electrodes has a significant impact on the performance of the battery, improving both specific energy (i.e., Wh/kg) and energy density (i.e., Wh/L) by reducing the weight and volume of electrode material that does not participate in the electrochemical reaction for energy storage. Additionally, binders in electrodes form a non-conductive layer on the surface of the electrode, which can negatively affect the electrode's performance. The use of binder-free electrodes can thus lead to a significant improvement in the performance and efficiency of rechargeable batteries. Binder-free and solvent-free electrode fabrication can not only benefit the environment by reducing the use of toxic and flammable solvents, but it may also significantly reduce the cost of energy storage. The elimination of binders and solvents can reduce manufacturing steps and streamline production, resulting in a more efficient and cost-effective process.

It should be noted that the system and method for solvent-free (dry) direct powder bed formation and compression contemplated herein may also have applications beyond battery technology. While the following discussion is done in the context of fabricating battery electrodes for rechargeable batteries, the system and method may be adapted for use in manufacturing other devices or components, both known in the art and as of yet undeveloped.

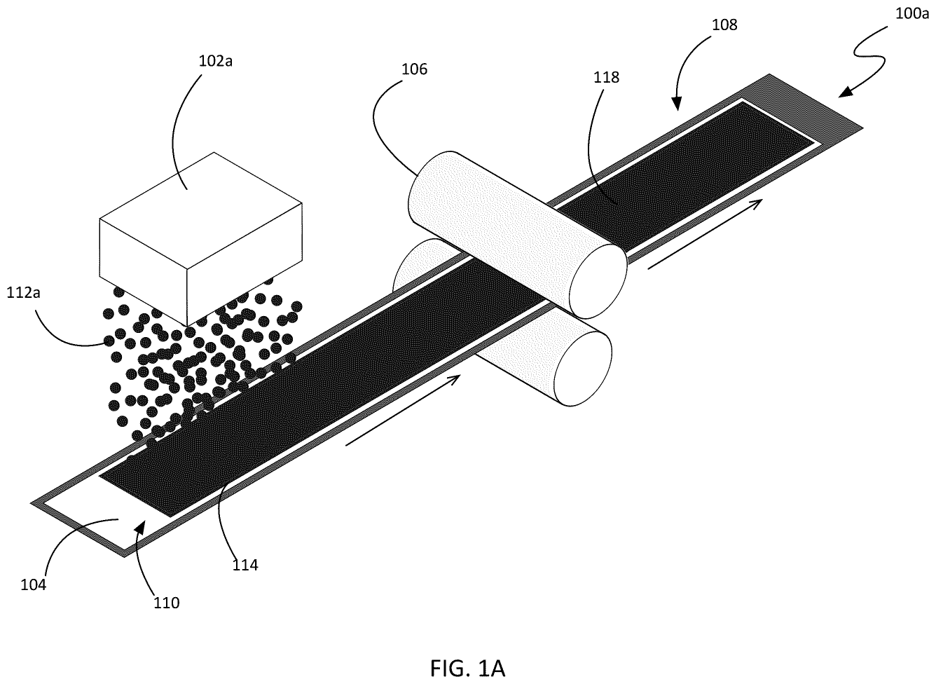

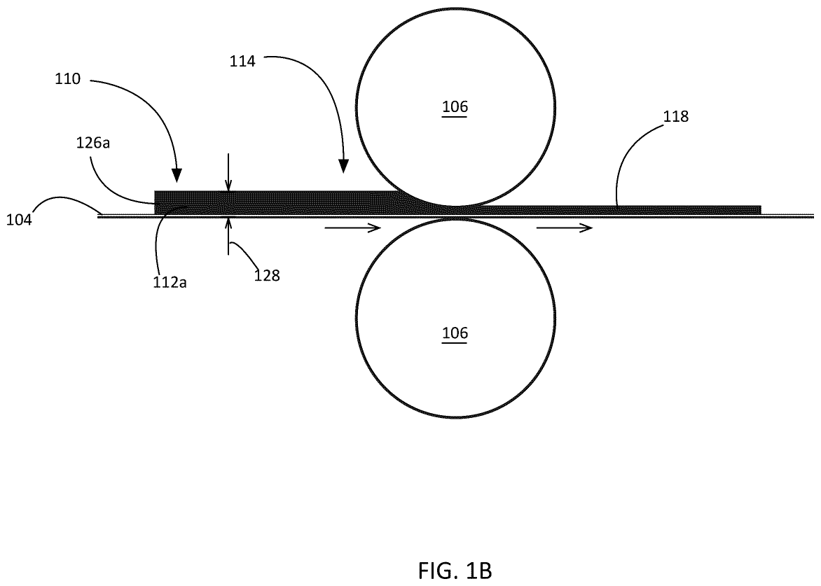

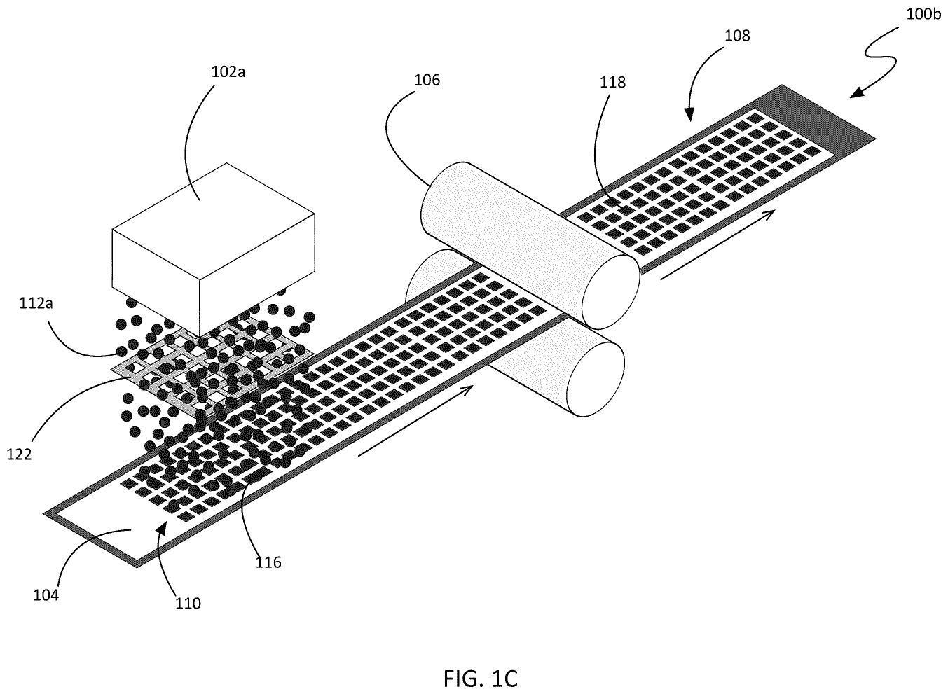

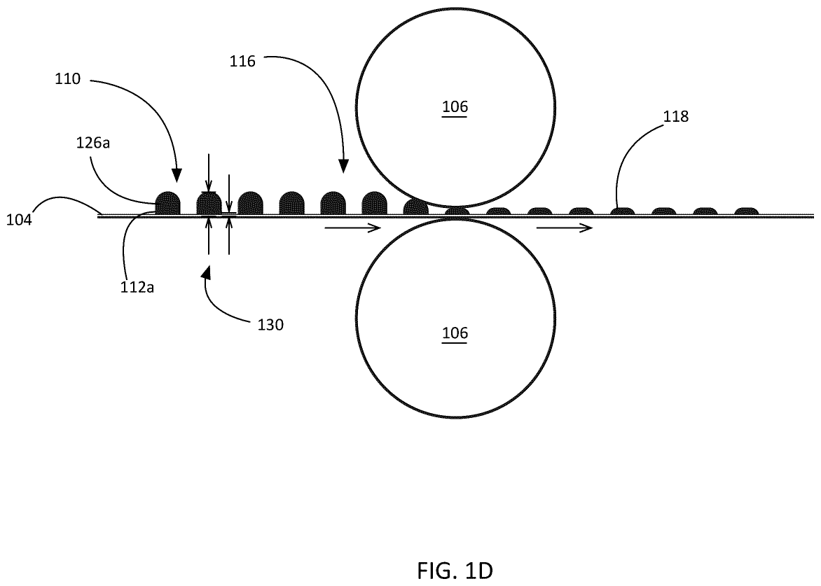

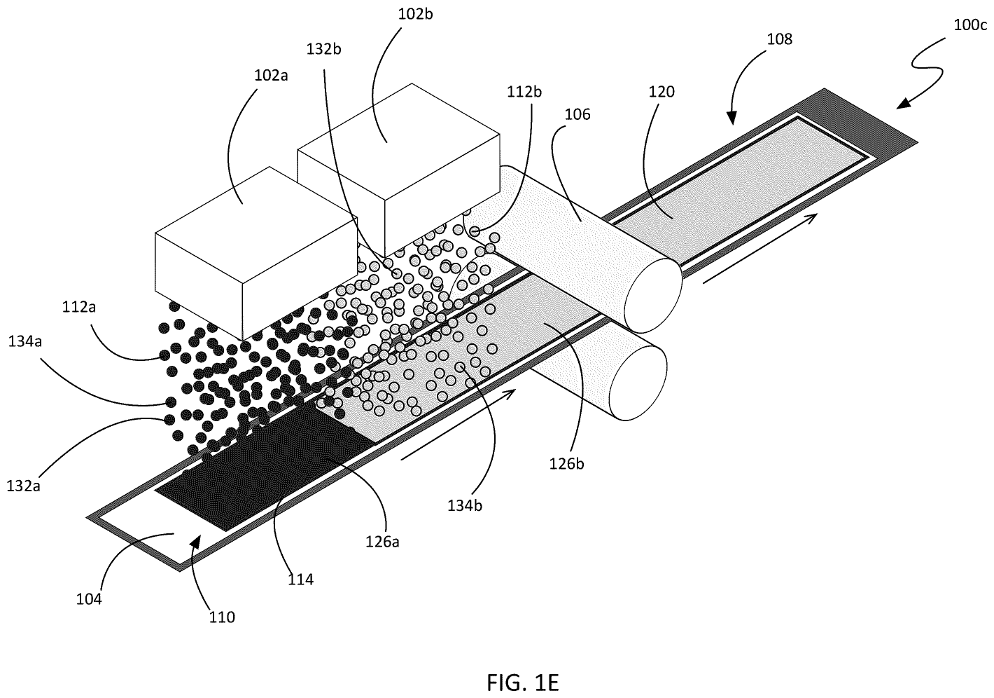

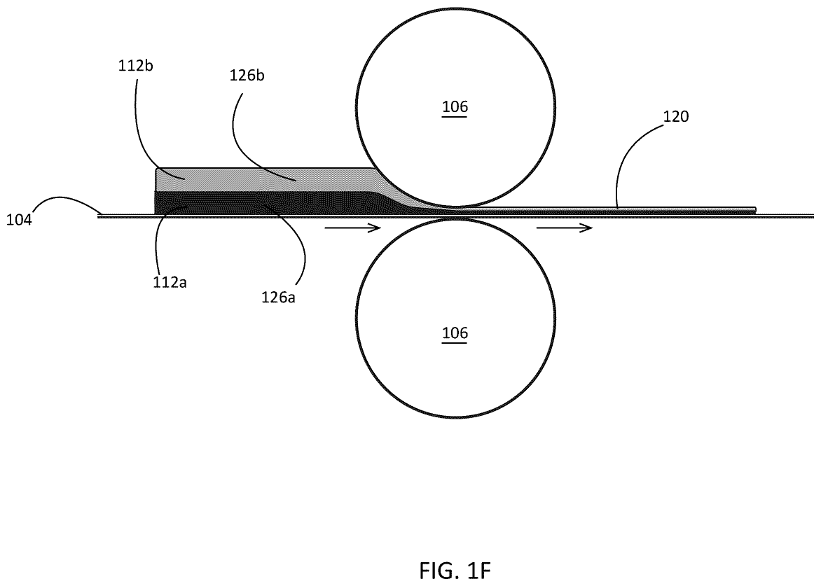

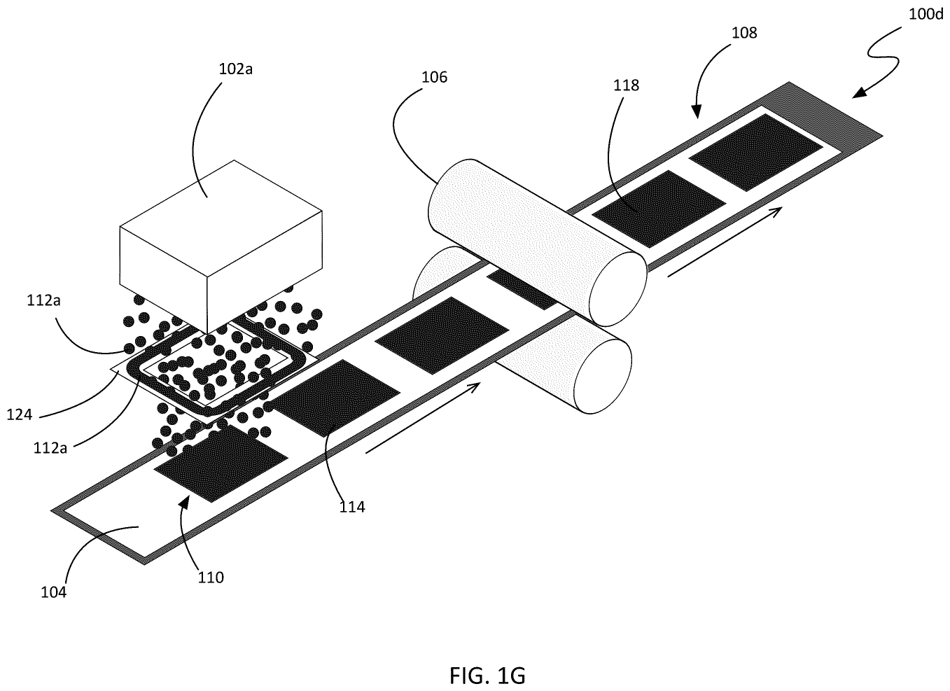

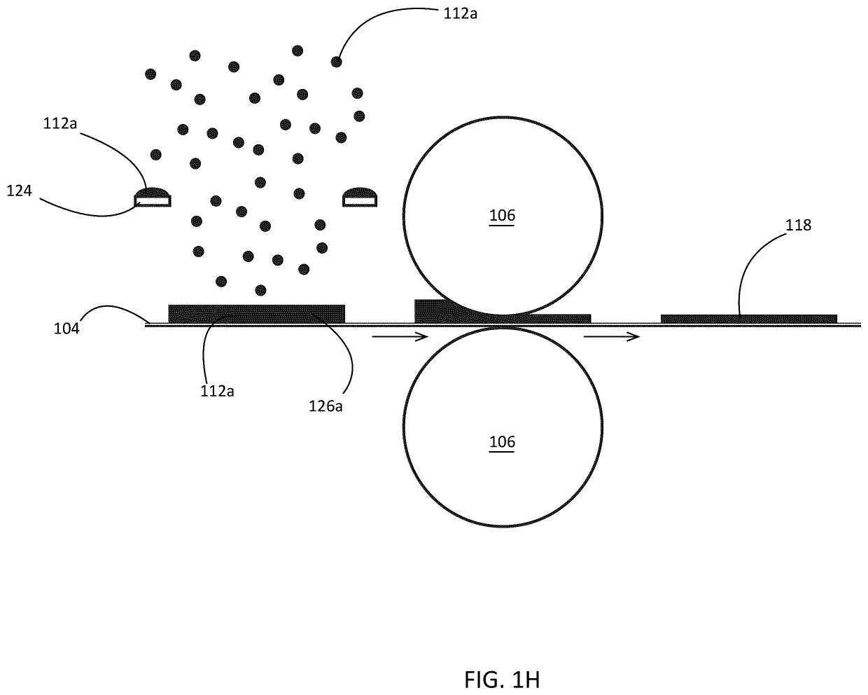

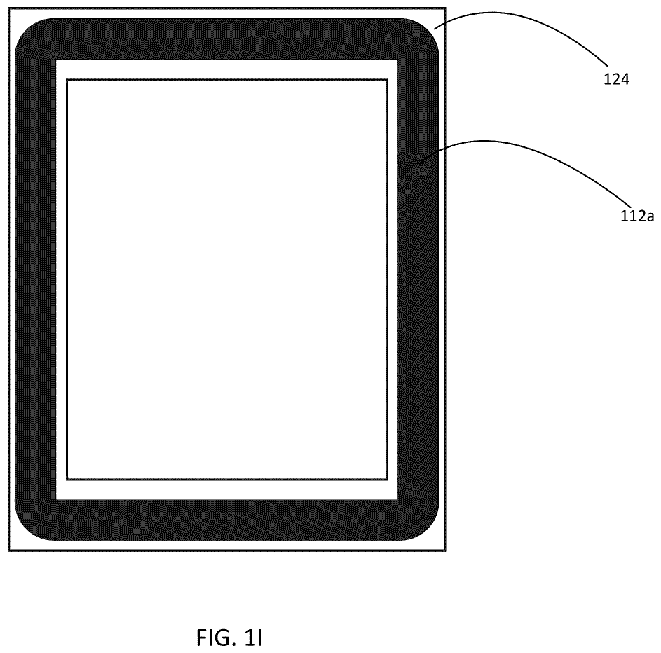

FIGS. 1A-1I show various non-limiting examples of implementations of the contemplated system for dry battery manufacturing. Specifically, these figures show both phases of the method (i.e., powder bed formation and compression), in four different embodiments. Each will be discussed in turn.

FIG. 1A shows a perspective view of a non-limiting example of a dry fabrication system 100a for fabricating battery electrodes 108 having a monolayer electrode film 118 using a single electrode powder. FIG. 1B shows a cross-sectional view of the heat-roll press 106 and dry powder bed 110 of the dry fabrication system 100a of FIG. 1A. According to various embodiments, the dry fabrication system 100 comprises at least one powder dispensing unit 102 (i.e. first powder dispensing unit 102a) and a heat-roll press 106. The powder dispensing unit 102 is positioned above a current collector 104 that is being fed into the heat-roll press 106 (e.g., on a belt, etc.). As will be discussed below, the powder dispensing unit 102 dispenses an electrode powder 112 (i.e., first electrode powder 112a) onto the current collector 104, forming a dry powder bed 110 that is a layer 114 of electrode powder 112. The dry powder bed 110 and the dry powder bed 110 are compressed by the heat-roll press 106, forming a battery electrode 108, according to various embodiments.

According to various embodiments, the battery electrode 108 produced by the contemplated dry fabrication system 100a and method is composed of a current collector 104 adhered to an electrode film 118 made of at least one electrode powder 112. In the context of the present description and the claims that follow, an electrode powder 112 (i.e., first electrode powder 112a, second electrode powder 112b, etc.) is a solvent-free powder comprising the solid constituents of the electrode coating including, but not limited to, active materials, binder(s) and conductive additive(s). According to various embodiments, the electrode powder 112 is a composite of these solid constituents that has been mixed in advance of the creation of a dry powder bed 110 on the current collector 104, to ensure a homogeneous mix of constituents.

Examples of active materials include carbonaceous active material (e.g., graphite, hard carbon, etc.), group IV elements (e.g., silicon, germanium, tin, etc.), layered transition metal oxides (e.g., lithium cobalt oxide, lithium nickel manganese cobalt oxides, lithium nickel cobalt aluminum oxides, lithium titanium oxides, etc.), olivine phosphate (e.g., lithium iron phosphate), spinel lithium manganese oxide, sulfur, polymers and the like. Exemplary conductive additives include, but are not limited to, conductive carbon.

In some embodiments, an electrode powder 112 may comprise a polymer binder, while in other embodiments, an electrode powder 112 may be binder-free (e.g., the first electrode powder 112a is entirely composed of an active material, the first electrode powder 112a is a composite of an active material and a conductive additive, etc.).

A binder-free electrode powder 112 is feasible when the active material has appropriate physical properties like a low melting temperature or high softness. Having such properties means that this binder-free electrode powder 112 can be deformed and form a dense layer together with other materials when exposed to the pressure and heat of the heat-roll press 106. This is unlikely to happen with conventional battery electrode materials such as ceramic cathode materials, and the like.

As a specific example, in one embodiment, the first electrode powder 112a may comprise sulfur as an active material. Due to the low melting temperature of sulfur and the ease with which it deforms, it can form a nicely uniform electrode, with the sulfur behaving like an active material and a binder.

Fabricating a battery electrode without needing a binder can provide an advantage over conventional systems and methods of fabrication, both in terms of price as well as energy density. In conventional battery electrodes, roughly 3-7% of the weight is a binder material. A mechanically sound electrode made without binder, at the same mass or same thickness as a conventional electrode, will have more active material. The result is a battery electrode 108 that has a superior energy density.

Additionally, the binder is typically an inactive material. Omitting the binder, which has a cost but does not itself contribute to energy storage, enhances the cost effectiveness and the energy density.

According to various embodiments, the dry fabrication system 100 comprises at least one powder dispensing unit 102 positioned above the current collector 104. For example, as shown, the dry fabrication system 100a of FIG. 1A has a first powder dispensing unit 102a located above the metallic current collector 104 that is being fed into the heat-roll press 106. A powder dispensing unit 102 (e.g., first powder dispensing unit 102a, second powder dispensing unit 102b, etc.) is configured to dispense an electrode powder 112 (e.g., first electrode powder 112a, second electrode powder 112b, etc.) such that the powder falls onto the current collector 104, forming a uniform electrode powder layer 114 (e.g., first layer 126a, etc.) which is at least part of the dry powder bed 110. In some embodiments, there may be additional structural elements between the dispenser and the current collector 104, which will be discussed in the context of FIGS. 1C and 1G, below.

As is known in the art, a current collector 104 is a fundamental component in a battery electrode. According to various embodiments, the current collector 104 is a metallic, conductive material that facilitates the flow of electrons between the electrode's active material and an external circuit or load during the charging/discharging processes. Examples of current collectors 104 employed through the contemplated dry fabrication method and system include, but are not limited to, sheet type, mesh type, foam type, mat type, and the like.

The contemplated dry fabrication system 100 comprises a heat-roll press 106. In the context of the present description and the claims that follow, a heat-roll press 106 (also known as a rotary heat press or a calendar) comprises at least one roller or drum that can exert pressure as well as heat on a material passing through, as is known in the art. According to various embodiments, the heat-roll press 106 is configured to receive the current collector 104 and compress a dry powder bed 110 and the current collector 104 together to form an electrode film 118 that is adhered to the current collector 104. Together, the electrode film 118 and the current collector 104 to which it is adhered form a battery electrode 108.

According to various embodiments, the method for the solvent-free fabrication of a battery electrode 108 has two stages: formation of a dry powder bed 110, and compression of the dry powder bed 110. The dry powder bed 110 is formed on top of a current collector 104 by dispensing an electrode powder 112 (i.e., first electrode powder 112a) directly onto the current collector 104 as an electrode powder layer 114 (i.e., first layer 126a).

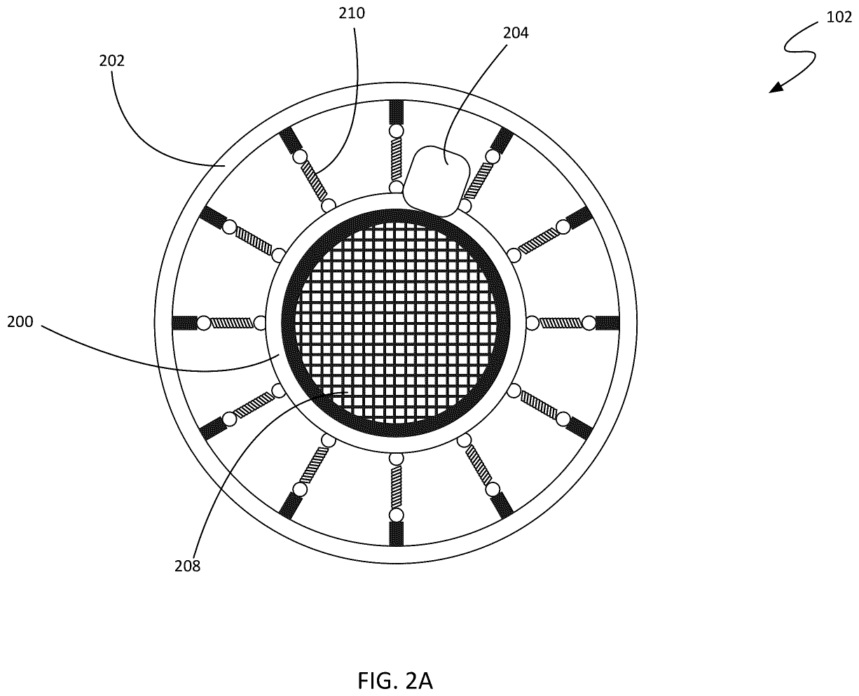

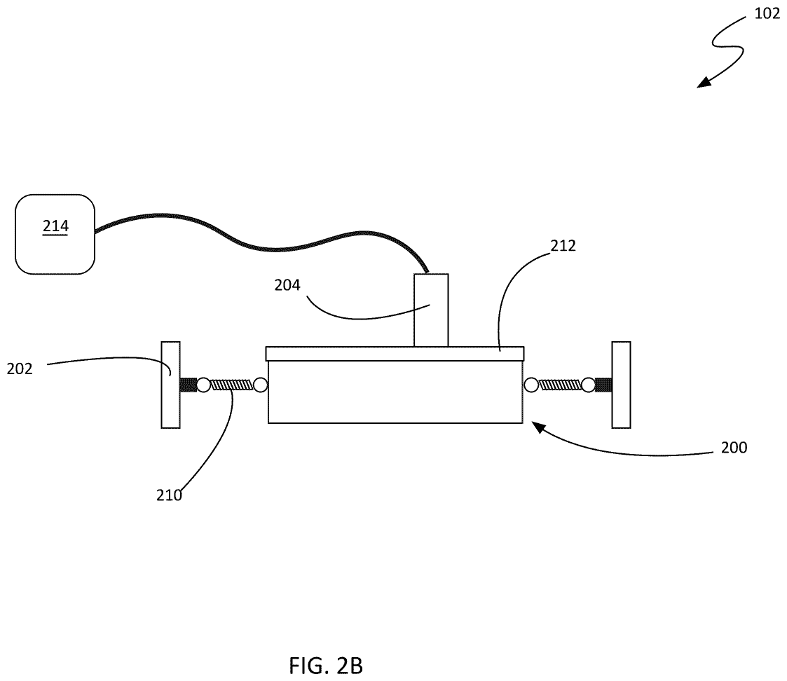

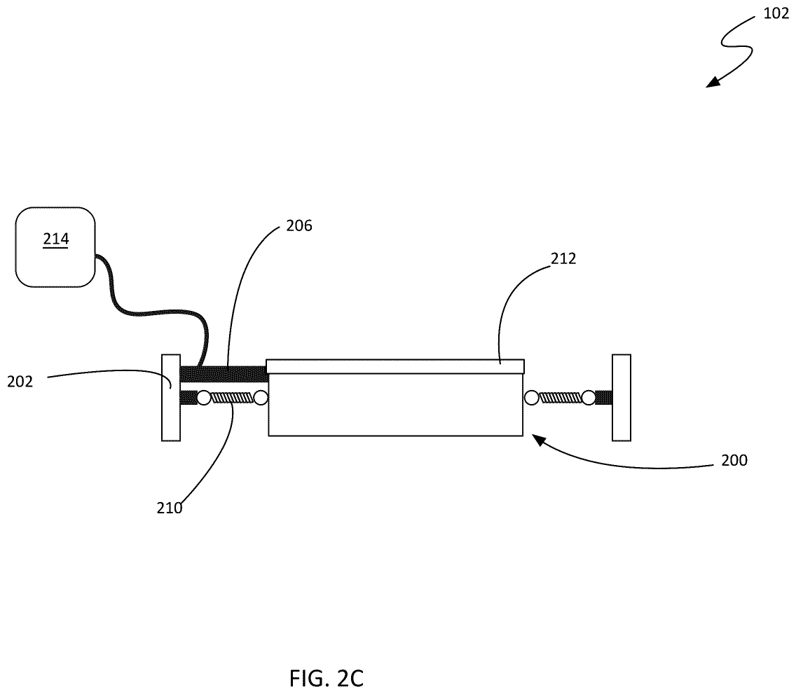

Looking to the non-limiting example in FIG. 1A, the first electrode powder 112a is dispensed evenly on the current collector 104 (e.g., metallic foil, porous metal or carbon meshes, etc.), such that it will have a desired powder areal mass loading (mg/cm²). In some embodiments, the formation of the dry powder bed 110 is a continuous process. In some embodiments, the dry powder bed 110 may be formed using a first powder dispensing unit 102a. The powder dispensing unit 102 will be discussed further with respect to FIGS. 2A-2C, below. In other embodiments, the first electrode powder 112a may be dispensed using a different method or device that is capable of dispensing a uniform layer of powder.

The next phase is compression. According to various embodiments, the compression is accomplished through a heat-rolling process. The dry powder bed 110 and the metallic current collector 104 are transferred to a heat-roll press 106 where they are compressed together to form an electrode film 118 adhered to the current collector 104. Heating the rolls during the press helps to improve the adhesion and cohesion of the electrode film 118 prepared by the process. By controlling the temperature and pressure given by the rolls, the solid component in the electrode powder 112 (e.g., sulfur in sulfur cathodes, polymer binder, etc.) can be deformed, compacted, and partially sintered, resulting in mechanically stable electrode film 118 adhered to the current collector 104 that together form the battery electrode 108.

According to various embodiments, the amount of electrode powder 112 dispensed onto the current collector 104, the roll-press gap, the feeding speed, and the roll temperature will determine the electrode thickness and porosity. According to some embodiments, this thickness of the electrode can range from tens of microns to millimeters.

In some embodiments, the electrode film 118 may be multilayer (see the multilayered electrode film 120 of FIGS. 1E and 1F). In other embodiments, including the non-limiting example shown in FIGS. 1A and 1B, the electrode film 118 may be monolayer, and formed from a single electrode powder 112. As shown in FIG. 1B, this monolayer film may comprise a single layer (e.g. first layer 126a) having a thickness 128.

FIG. 1C shows a perspective view of a non-limiting example of a dry fabrication system 100b for battery electrodes comprising a patterned powder layer 116. FIG. 1D shows a cross-sectional view of the heat-roll press 106 and dry powder bed 110 of the dry fabrication system 100b of FIG. 1C.

The non-limiting example of a dry fabrication system 100a shown in FIG. 1A yielded a monolayer battery electrode 108, whose first layer 126a had a uniform thickness 128. According to various embodiments, the powder dispensing units 102 (e.g., first powder dispensing unit 102a, etc.) contemplated herein distribute and dispense electrode powder 112 (e.g., first electrode powder 112a, etc.) such that it falls onto the current collector 104 and forms a uniform layer (e.g., first layer 126a, etc.). In some embodiments, a structure may be positioned between a powder dispensing unit 102 and the current collector 104 that disrupts that uniform deposition of electrode powder 112 in a consistent and deliberate manner.

According to various embodiments, the dry fabrication system 100b and method contemplated herein may be used to form a micro pattern in the electrode film 118. This is accomplished by dropping the electrode powder 112 (e.g., first electrode powder 112a, etc.) through a patterning screen 122 as it is dispensed onto the metallic current collector 104, forming void regions in the dry powder bed 110 which will become a pattern in the electrode film 118 after compression.

In the context of the present description and the claims that follow, a patterning screen 122 is a structure that serves as a mask for electrode powder 112 after it has been dispensed by a powder dispensing unit 102. The patterning screen 122 comprises at least one hole or aperture large enough for particles of the electrode powder 112 being “patterned” can pass through. According to various embodiments, when the dispensed electrode powder 112 falls onto a patterning screen 122, it will fall through the at least one aperture or be deflected by the patterning screen 122 around the at least one aperture. In some embodiments, a small amount of electrode powder 112 may collect on top of the patterning screen 122. Essentially, the patterning screen 122 functions as a mask, causing the dispensed electrode powder 112 to fall onto the current collector 104 (or an already dispensed electrode powder layer 114) and becoming part of the dry powder bed 110 as a patterned powder layer 116. According to various embodiments, a patterned powder layer 116 is an electrode powder layer 114 having a meticulously controlled micro-patterned heterogeneity in thickness (e.g., having void regions, thin segments, thick segments, etc.), as shown FIG. 1D as micro-patterned thickness variations 130.

In the non-limiting example shown in FIG. 1C, the patterning screen 122 is a mesh, having a grid of openings that cause the falling first electrode powder 112a to form an array of separated powder structures, as shown. Other embodiments of the patterning screen 122 may have other numbers, sizes, arrangements, and/or shapes of apertures.

The non-limiting example of a dry fabrication system 100b shown in FIGS. 1C and 1D yields a battery electrode 108 having an electrode film 118 that is both monolayer as well as patterned. In some embodiments, a patterned powder layer 116 may be the only layer in the dry powder bed 110, while in other embodiments a patterned powder layer 116 may be deposited on top of another electrode powder layer 114, or have another electrode powder layer 114 deposited on top of the patterned powder layer 116. In still other embodiments, the dry powder bed 110 may be made up of one or more electrode powder layers 114 that each have a thickness 128 that is uniform throughout the layer.

FIG. 1E shows a perspective view of a non-limiting example of a dry fabrication system 100c for battery electrodes 108 comprising a multilayered electrode film 120. FIG. 1F shows a cross-sectional view of the heat-roll press 106 and dry powder bed 110 of the dry fabrication system 100c of FIG. 1E. According to various embodiments, multiple electrode powder layer 114 may be deposited on the metallic current collector 104, forming a dry powder bed 110 that is layered. In some embodiments, including the non-limiting example shown in FIG. 1E, this may be done using multiple powder dispensing units 102 (e.g., first powder dispensing unit 102a, second powder dispensing unit 102b, etc.) in sequence, while in other embodiments, a different method or mechanism may be used. As an option, one or more of the electrode powder layer 114 making up the multilayered dry powder bed 110 may be a patterned powder layer 116 through the use of a patterning screen 122 as discussed in the context of FIG. 1C, above.

In the non-limiting example of a dry fabrication system 100c shown in FIG. 1E, the dry powder bed 110 is formed on top of the current collector 104 by dispensing a first electrode powder 112a as a first layer 126a using a first powder dispensing unit 102a, and then dispensing a second electrode powder 112b as a second layer 126b directly onto the first layer 126a. After being compressed by the heat-roll press 106, this layered dry powder bed 110 yields a multilayered electrode film 120 adhered to the current collector 104.

The electrode film 118 prepared using the contemplated method can be composed of as many different kinds of electrode powder 112 as desired, since each electrode powder layer 114 can be applied sequentially. This is not possible to do using conventional dry or wet coating processes. Additionally, this process can be used to form a compositional or microstructural (e.g., pore size, particle size, material, etc.) variation in three dimensions by implementing multiple electrode powder layers 114.

Currently, battery electrodes are manufactured roll-to-roll (R2R) using slot-die processes to coat slurries onto thin metal foils of copper for the anode and aluminum for the cathode. One of the challenges of the conventional R2R process is to manufacture a thick electrode to enhance energy density by reducing inactive components (e.g., carbon, binder, current collector 104, etc.) while also maintaining rate capability power density. However, preparing thick films via the wet-slurry-based R2R process is challenging due to the propensity for dried electrodes to crack. The battery rate capability and power density also degrades in thick electrodes due to ill-defined electronic and ionic percolation networks arising from their uncontrolled random microstructure. This increases the ohmic resistance and limits the fast-charging capability of the battery. The addition of more conducting additives to the electrode only decreases the energy density further by increasing the weight of inactive components.

Efforts to improve the intrinsic materials properties of the active materials (e.g., through doping for higher conductivity, etc.) show promise but are still in development. Three-dimensional (3D) electrodes with appropriate physical properties (e.g., porosity, tortuosity, active material contents, etc.) can offer high energy and power density simultaneously, due to their unique structural properties. The ability to fabricate these electrodes would permit the deliberate and controlled design of electrode microstructure having compositionally and structurally efficient electronic transport pathways (e.g., the interconnection between the current collector 104 and active material surrounded by electrically conducting carbon, etc.) and ionic conduction channels (e.g., the interconnection of the electrolyte-filled pores, etc.), resulting in better electrochemical reaction kinetics.

There are several 3D manufacturing techniques for 3D lithium-ion battery (LIB) electrodes, such as direct ink writing (DIW), fused deposition modeling (FDM), laser ablation, and ice templating methods (e.g., freeze tape casting). However, these approaches are not likely to produce high-energy density LIB electrodes because they introduce a significant amount of additives that increase batteries' ‘dead weight’ (i.e., the weight of inactive components that do not contribute to charge storage) and/or have high manufacturing throughput time. For example, DIW can fabricate 3D LIB electrodes by dispensing ink through a computer-controlled nozzle. However, this process requires organic solvents with excessive polymer content (e.g., 30 wt % PVDF in LiMn_{0.21}Fe_{0.79}PO₄ cathode). This is because the shape of the electrode can be hard to maintain prior to curing, and the rheological properties of the cast electrode can be difficult to control with lower polymer binder content. However, having large fractions of electronically insulating polymers in the slurry is not desirable since they deteriorate the power characteristics of the electrodes as well as energy density. FDM uses an extrusion process with a solid-state filament such as polylactic acid (PLA) mixed with graphite or graphene to improve electronic conductivity. However, FDM also requires a high polymer content (e.g., graphite to PLA weight ratio=7:323).

Laser ablation introduces the need to remove materials from the electrode film 118 to create 3D structures, which can increase the manufacturing cost significantly. Ice-templating methods (e.g., freeze tape casting) can be used to build 3D-aligned microstructures in the electrodes. However, long processing times, the need for an ultra-high vacuum to remove the ice template, and a limited selection of processing solvents are practical hurdles preventing their widespread application. In addition, geometrical control of the 3D array of the electrode film 118 (e.g., interlayer space, density, etc.) is not easy to achieve, and the mechanical properties of freeze-cast electrodes are often poor. Advantageously, the contemplated dry fabrication method can be used to prepare compositionally or structurally 3D patterned electrodes, without requiring the additional materials, removal of materials, and/or expense of conventional methods to create a 3D structure in the electrode film 118.

3D-designed electrodes with appropriate variation of physical properties (e.g., porosity, tortuosity, particle size, active material content, etc.) along a particular direction can offer high energy density and high-power density simultaneously, due to their unique structural properties. According to various embodiments, the 3D electrode microstructure with engineered 3D porosity (e.g., low tortuosity, the improved interconnection of particles, etc.) able to be produced using the methods contemplated herein establishes efficient electron/ion transport pathways in all three dimensions, leading to better electrochemical reaction kinetics without sacrificing energy density. The conventional wet-slurry process is unable to construct battery electrodes with suitable 3D structures due to the following reasons: (1) it is extremely hard to keep a wet slurry structured with complex 3D structures as the liquid slurry naturally flows due to gravity, (2) slurry casting can be prone to issues such as settling of solid particles or uneven distribution of components, leading to undesirable variations in composition and properties across the electrode, and (3) during the drying of slurry, film shrinkage can occur, leading to deformations and cracks in the structure, making it necessary to explore new approaches for realizing 3D electrode designs. Subtractive methods such as laser etching can fabricate 3D structures, but they can cause thermal damage to the material surrounding the patterns and increase the manufacturing cost ($/Wh) as it creates the 3D structure by removing the materials.

It should be noted that when speaking of imparting three dimensional structure to an electrode film 118, it can be referring to the inclusion of one or more patterned powder layers 116 in the dry powder bed 110 that move the structure away from the standard planar topology. However, it may also refer to stacked planar electrode powder layers 114 that vary in some other aspect.

For example, in the non-limiting example shown in FIG. 1E, a dry fabrication system 100c may employ a first powder dispensing unit 102a dispensing a first electrode powder 112a as well as a second powder dispensing unit 102b that is dispensing a second electrode powder 112b. In some embodiments, the first electrode powder 112a and the second electrode powder 112b may have the same composition, but different particle sizes. For example, in one embodiments, the first electrode powder 112a has a first particle size 132a, and the second electrode powder 112b has a second particle size 132b that is different from the first particle size 132a.

In some embodiments, the first electrode powder 112a may have a first composition 134a (e.g., an active material and a polymer binder) and the second electrode powder 112b may have a second composition 134b (e.g., pure active material) that is different from the first composition 134a, yet both powders may have roughly the same particle size.

Additionally, in some embodiments, the first electrode powder 112a may have a first composition 134a and a first particle size 132a, and the second electrode powder 112b may have a second composition 134b and a second particle size 132b that are different from the first composition 134a and first particle size 132a, respectively. As an option, in any of these example embodiments, one or both of the electrode powder layers 114 may be a patterned powder layer 116.

Although the non-limiting example of a dry fabrication system 100c shown in FIG. 1E yields a dry powder bed 110 having two layers (i.e., first layer 126a and second layer 126b), in other embodiments a multilayered electrode film 120 may be fabricated using a dry powder bed 110 having three, four, or more electrode powder layers 114. As a specific, non-limiting example, in one embodiment, the dry fabrication system 100 may have three different powder dispensing units 102, each dispensing a different electrode powder 112. These powders are only slightly different. The first electrode powder 112a is composed of 90% active material, with the rest being binder and a carbon conductive additive. The second electrode powder 112b may have 93% active material, and the third electrode powder may have 95% active material. Such an arrangement is beneficial in circumstances where the higher binder content is needed to improve the adhesion properties between the current collector 104 and the multilayered electrode film 120. The additional binder can be in the bottom layer, with the second and third layers being higher in active material content, yielding a higher energy density that would be possible with a single layer having sufficient binder content. This type of structural manipulation is not feasible in any of the conventional fabrication processes known in the art.

FIG. 1G shows a perspective view of a non-limiting example of a dry fabrication system 100d comprising a window frame 124. FIG. 1H shows a cross-sectional view of the heat-roll press 106 and window frame 124 of the dry fabrication system 100d of FIG. 1G. FIG. 1I shows a top view of the window frame 124 of the dry fabrication system 100d of FIG. 1G.

Conventional systems and methods for fabricating battery electrodes typically involves the creation of sheets of electrode that are subsequently cut to the desired size. The unused portion is often discarded as waste. Advantageously, the dry fabrication system 100d and method contemplated herein provides a way to accomplish near net shaping manufacturing (e.g., a process that aims to produce components that are as close as possible to their final or net shape during the initial manufacturing steps, thereby minimizing or eliminating the need for additional machining or finishing operations) by optimizing powder usage for the desired electrode size and enabling the reuse or reapplication of excess material collected on the window frame. This approach not only enhances manufacturing efficiency but also promotes sustainability by minimizing waste.

According to various embodiments, a window frame 124 is strategically positioned between the powder dispensing unit 102 and the current collector 104. The window frame 124 comprises an aperture surrounded by a frame. The edge of the aperture is the boundary where the falling electrode powder 112 should not settle as part of the dry powder bed 110. The window frame 124 could be thought of as a patterning screen 122 with a single hole in the shape and size of the desired battery electrode 108 (accounting for changes in size and shape that can be caused by the heat-roll press 106).

According to various embodiments, the electrode dry powder bed 110 can be formed in a particular dimension by employing a window frame 124 that only allows the powder deposition onto a specific area of a current collector 104. The screened electrode powder 112 by the window frame 124 can be collected and reused. This is advantageous over the conventional slurry-based electrode fabrication process, which cannot reuse unused powder in a mixture with other electrode components. According to various embodiments, the contemplated process allows for the collection and reuse of unused electrode powder 112 caught on the window frame 124.

FIGS. 2A and 2B show top and side views of a non-limiting example of a powder dispensing unit 102 (e.g., first powder dispensing unit 102a, second powder dispensing unit 102b, etc.). As shown, the powder dispensing unit 102 comprises a powder supply sieve 200 suspended within an outer frame 202 by a plurality of springs 210. The electrode powder 112 (e.g., first electrode powder 112a) is initially placed on the powder supply sieve 200, the sieve having an appropriate mesh size 208 that can hold the electrode powder 112 when no mechanical force is being applied to the powder supply sieve 200 (i.e., when the powder supply sieve 200 is essentially motionless). The mesh size 208 of the powder supply sieve 200 (and, in some embodiments, a stationary and optional patterning screen 122) can be adapted to work with various electrode powders 112, based on the physical properties of the powder 112. As an option, in some embodiments, the powder supply sieve 200 may be covered with a lid 212 (not shown in FIG. 2A).

There are numerous ways to apply mechanical force or vibration to the powder supply sieve 200 of the powder dispensing unit 102 in a controllable fashion, according to various embodiments. In some embodiments, the powder dispensing unit 102 may comprise a solenoid 204 positioned to repeatedly impact the powder supply sieve 200 (e.g., the lid 212, etc.), creating vibrations that cause the electrode powder 112 to fall through the powder supply sieve 200. As shown in FIG. 2B, a power supply 214 controls the tapping frequency of a solenoid 204, which affects the feeding rate of the electrode powder 112 to the metallic current collector 104 during the powder casting process. In a specific embodiment, once the solenoid 204 taps the lid 212 of the powder supply sieve 200, a certain amount of electrode powder 112 (determined by particle size and the sieve's mesh size) penetrates through the powder supply sieve 200 and is dropped to the current collector 104.

FIG. 2C shows a side view of a non-limiting example of another embodiment of the powder dispensing unit 102 where, instead of solenoid 204 tapping configuration, an ultrasound system is implemented, where the force is applied to the powder supply sieve 200 using a transducer 206. In both of these embodiments, the feeding rate (mg/sec) of powder is controlled by the frequency of tapping (or power and frequency of ultrasounds) that can be adjusted by a power supply 214 and the size of the holes of the powder supply sieve 200 relative to the particle size. Other embodiments may tap, vibrate, or otherwise disturb the powder supply sieve 200 using any device, mechanism, or method known in the art.

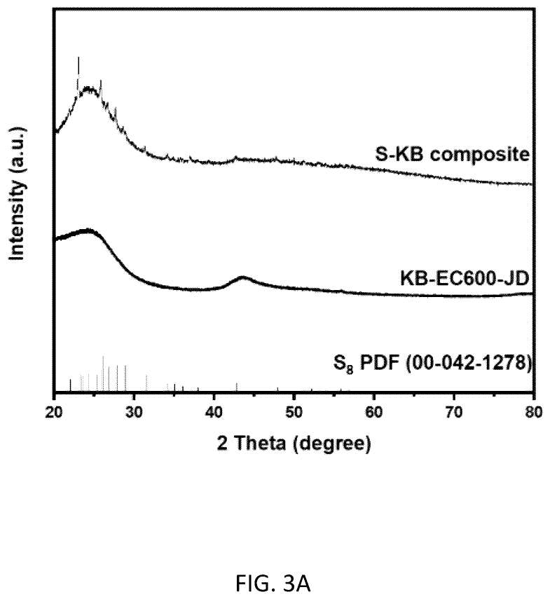

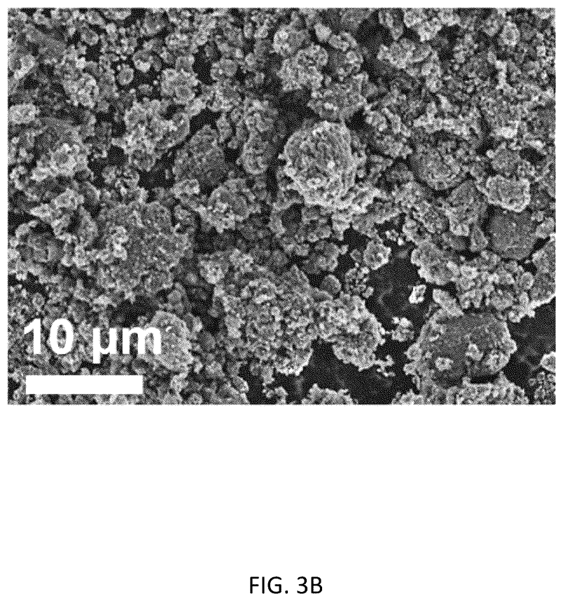

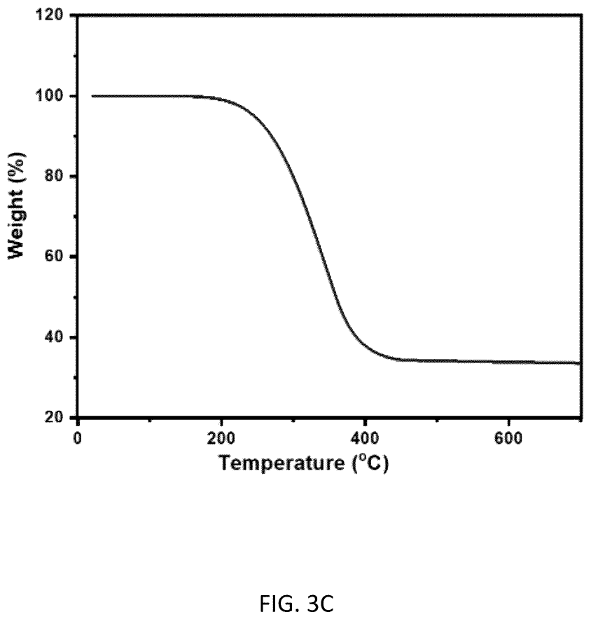

The following is a discussion of various properties of a collection of specific examples of electrode films 118 and battery electrodes 108 produced using the dry fabrication systems 100 and methods contemplated herein. FIGS. 3A-3C shows characterization results of a sulfur-Ketjen black (S-KB) nano-composite prepared using a dry fabrication system 100. Specifically, FIG. 3A shows X-ray diffraction patterns of S-KB nano-composite and Ketjen black (i.e., EC600-JD), FIG. 3B shows an SEM image of the S-KB nano-composite, and FIG. 3C shows a TGA result of the S-KB nano-composite. The sample was synthesized by thermal melt-diffusion process at 155° C. under an argon atmosphere, which was followed by griding and sieving processes. This S-KB nano-composite consisted of 70 wt. % S and 30 wt. % C, which is demonstrated by Thermal Gravimetric Analysis (TGA) shown in FIG. 3C. The S-KB composite was used to fabricate the binder-free sulfur electrode for lithium/sulfur (Li/S) batteries via the contemplated dry fabrication method.

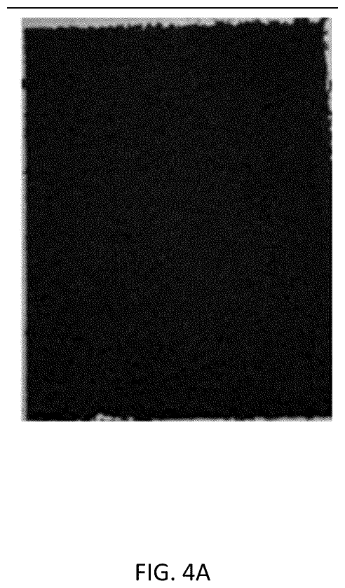

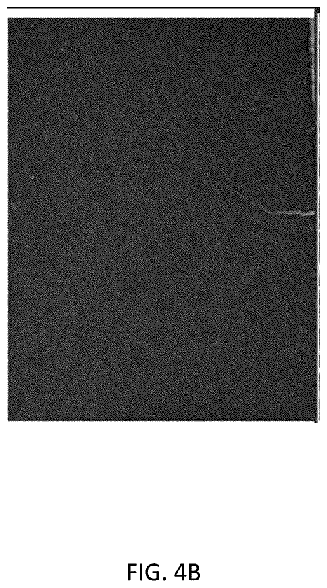

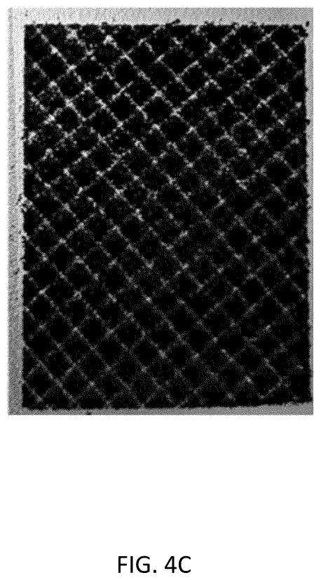

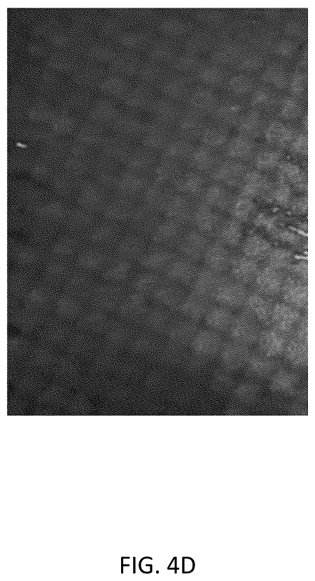

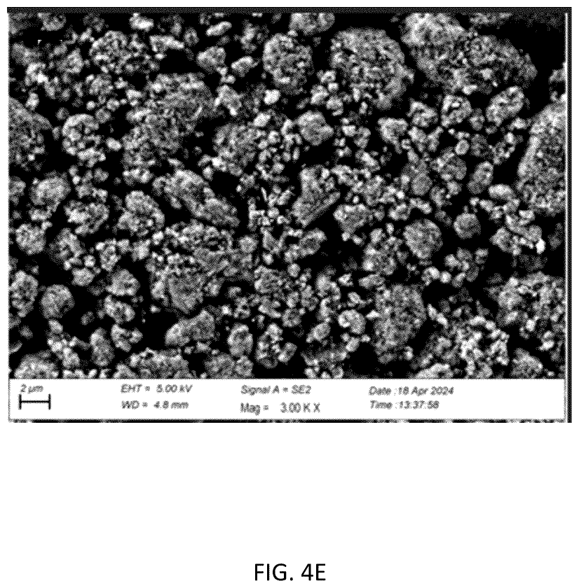

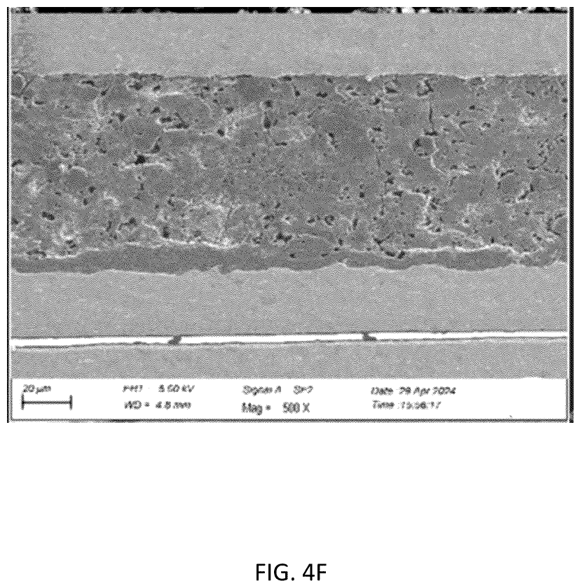

FIGS. 4A-4D show photos of a cast dry powder bed 110 and current collector 104, and the resulting battery electrode 108. FIGS. 4E and 4F show the top and cross-sectional SEM images of the S-KB electrode, respectively. As shown in FIGS. 4A and 4C, a uniform dry powder bed 110 of S-KB nano-composite (S: 70%, C: 30%, w/w) can be prepared in either a planar structure (i.e., FIG. 4A) or with patterns by using a patterning screen 122 (i.e., FIG. 4C). This choice dictates whether the resulting battery electrode 108 will be planar (i.e., FIG. 4B) or patterned (i.e., FIG. 4D) after undergoing the heat-roll press 106 process. The top and cross-sectional surface SEM images of the S-KB electrodes shown FIGS. 4E and 4F shows uniform porous structures. No polymer binder was used for the electrode preparation in any of these specific examples.

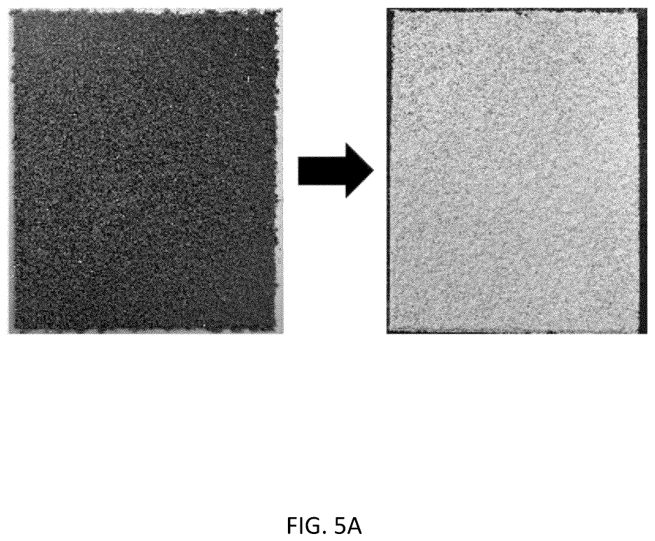

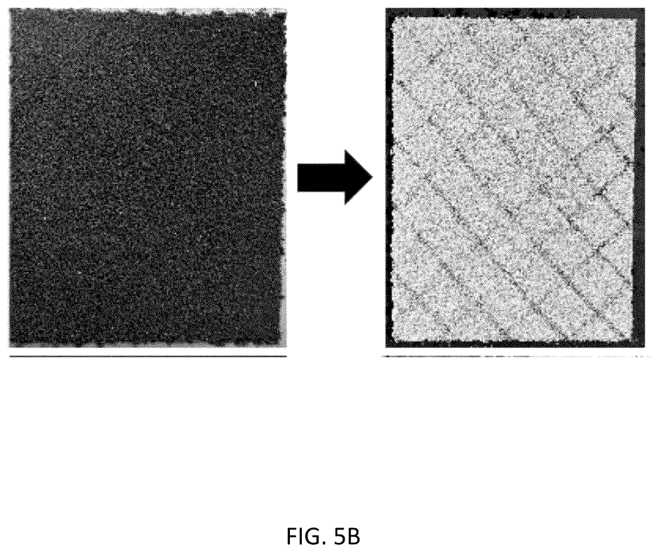

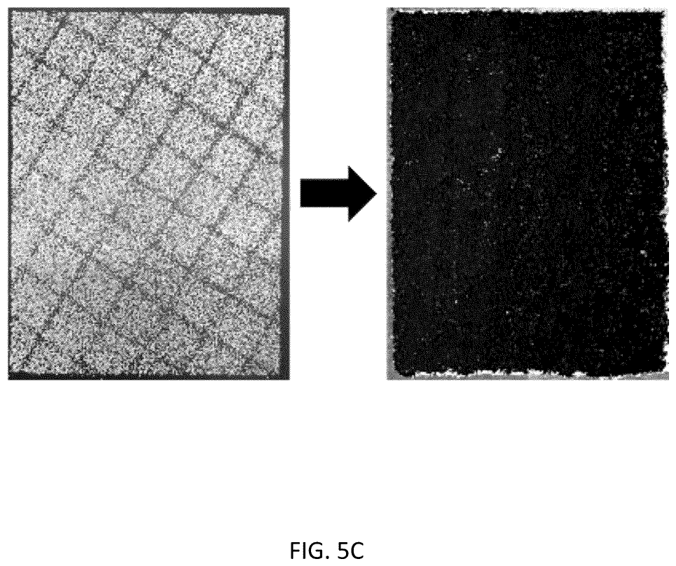

Diverse configurations of dry powder bed 110 formation are achievable through this process, enabling variations in microstructure and composition within battery electrodes, thus facilitating the production of 3D-designed electrodes. FIGS. 5A-5C show multi-layered dry powder bed configurations for 3D electrode fabrication. Specifically, FIG. 5A shows a planar-planar double layer, FIG. 5B shows a planar-patterned double layer, and FIG. 5C shows a patterned-planar double layer dry powder beds 110. The upper layer is deposited onto the lower layer. A sulfur-carbon composite (i.e., the dark powder) and sulfur (i.e. the light powder) are used to enhance visibility, although materials can vary in particle size, composition, and elemental properties, according to various embodiments.

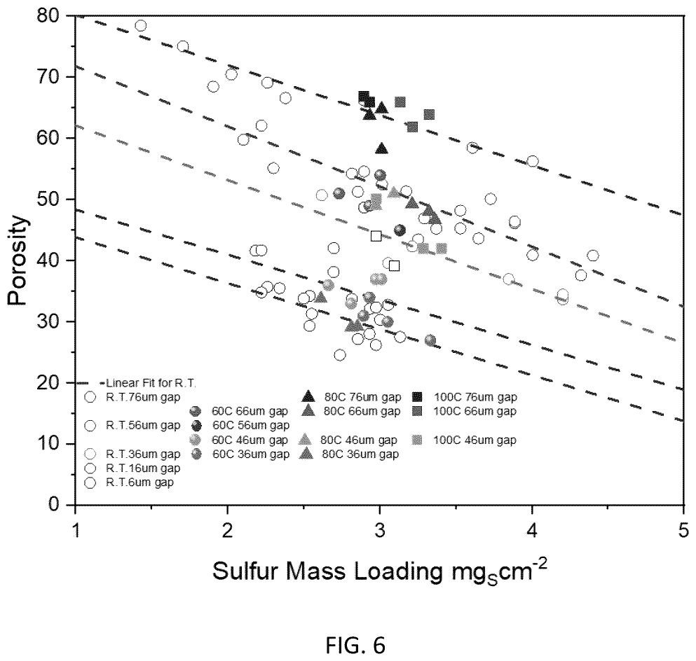

FIG. 6 shows experimental results illustrating the correlation between heat-roll press temperature and pressure (determined by the gap between the rolls) and the resultant porosity at specific sulfur mass loadings. As the roll temperature increases, the compression of the dry powder bed 110 becomes more efficient, leading to decreased porosity in the electrode at the same areal mass of the S/KB composite.

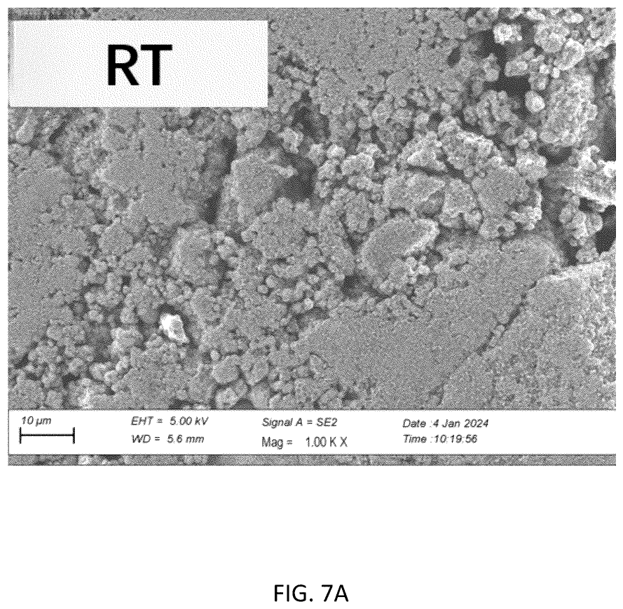

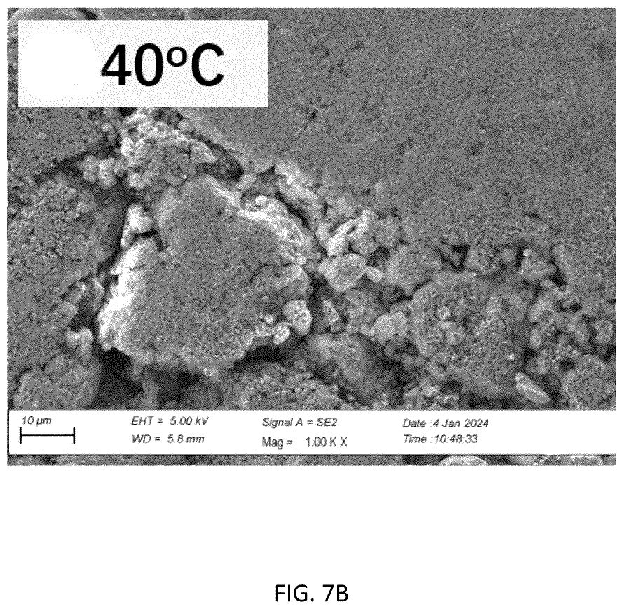

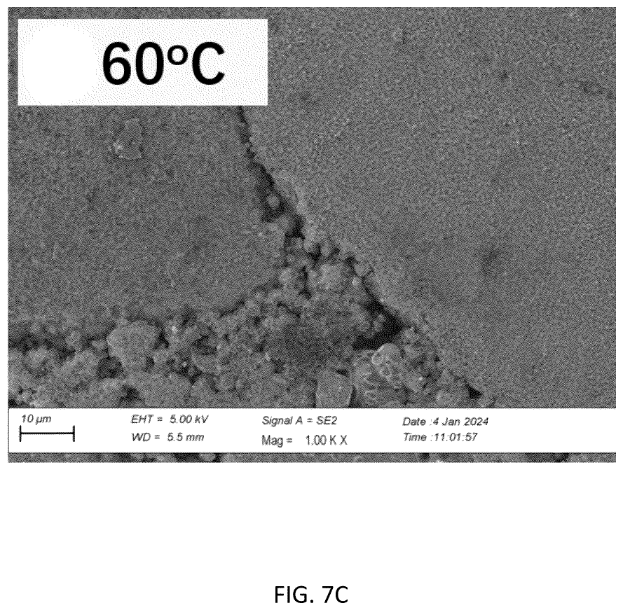

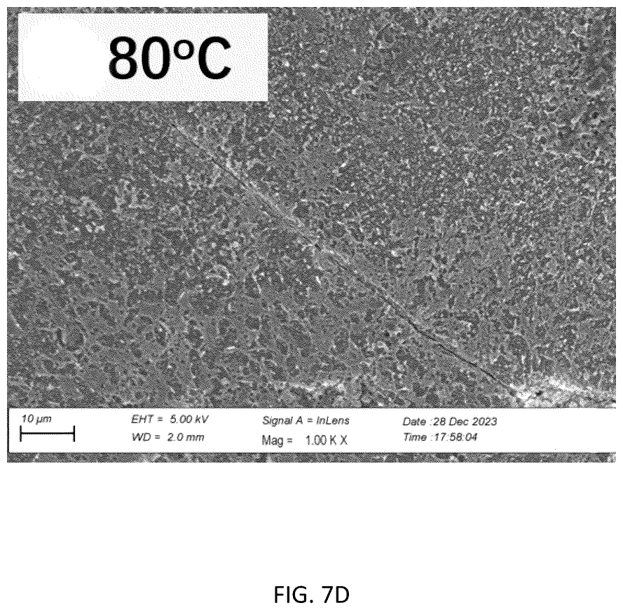

FIGS. 7A-7D show SEM images of a dry powder bed of elemental sulfur after being heat pressed at various temperatures. Sulfur pressed at elevated temperatures shows better surface uniformity and less cracks, indicating mass transfer at the margin of sulfur particles. This is attributed to the significant deformation of soft materials like sulfur and polymers at higher temperatures. With rising temperatures, the sulfur exhibits more pronounced longitudinal deformation due to the roll process. By understanding the thermal behavior of the dry powder bed 110 and the relationship between process parameters and the resulting physical properties of dry electrodes, the contemplated dry fabrication system 100 and method can fabricate electrodes with varying porosities across a broad range of electrode thicknesses.

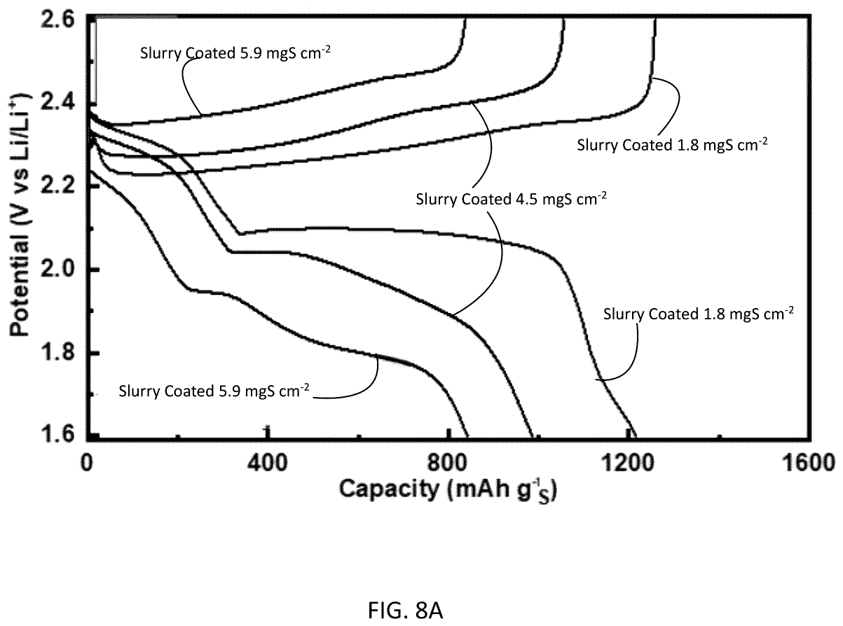

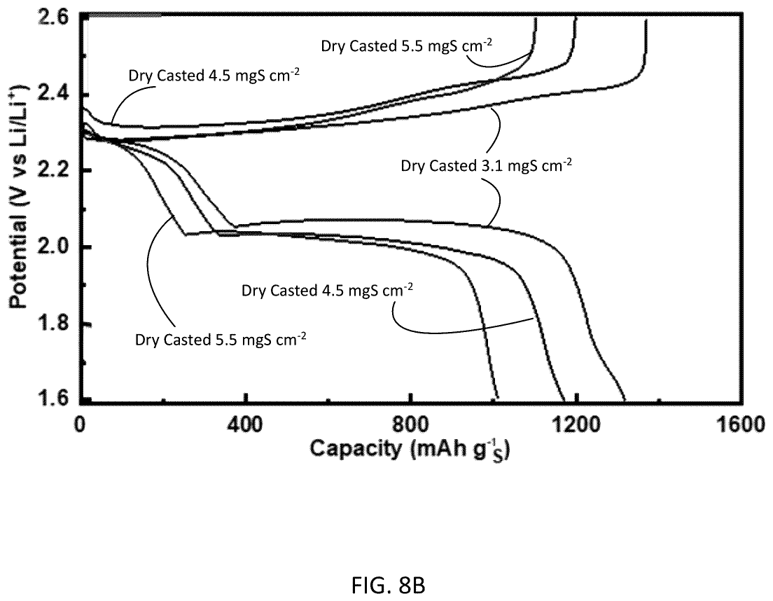

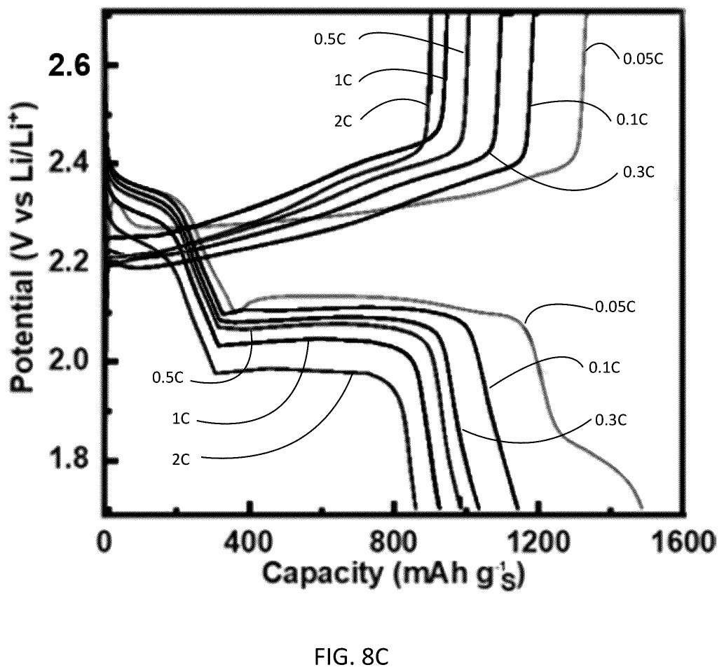

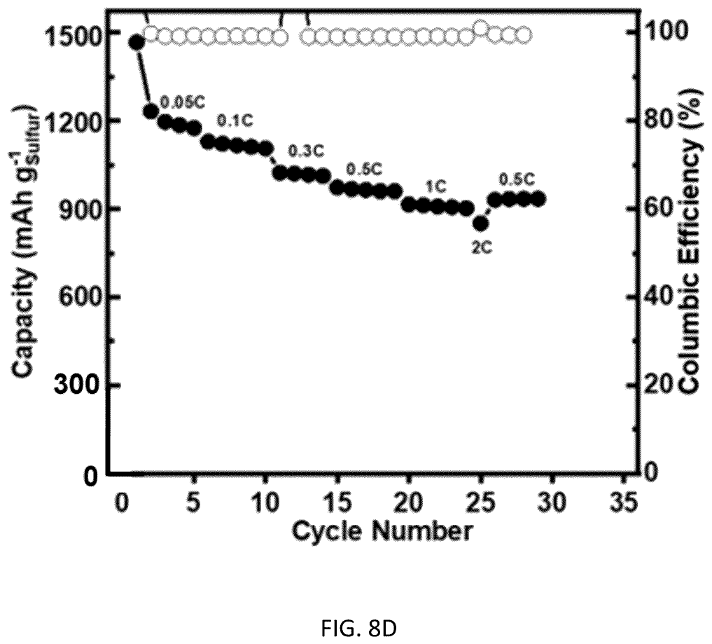

FIGS. 8A and 8B show voltage profiles of S/KB electrodes with various sulfur mass loadings prepared by the binder-free dry process and slurry casting process, respectively. The electrolyte was composed of 1M Lithium bis(trifluoromethanesulfonyl)imide in 1,2 dioxolane and 1,3 dimethoxymethane (1:1 v/v) with 0.2 wt. % lithium nitrate. The tests were performed in 2032 coin-type batteries. FIG. 8A shows the voltage profile for conventional slurry-cast electrode featuring LA133 polymer binder. The composition of this electrode, using the same S/KB composite as in the binder-free electrode, was sulfur:carbon:binder=63:30:7 (w/w). Of the total carbon content, 27 parts are attributed to Ketjen black from the S/KB composite, while the remaining 3 parts are Super P, added separately to the slurry. FIG. 8B shows the voltage profile for binder-free electrodes prepared via the dry fabrication method contemplated herein.

FIGS. 8C and 8D show voltage profiles and a specific capacity vs. cycle number plot for different rate capabilities of a binder free S/KB nano-composite electrode, respectively. The prepared binder free S/KB electrodes exhibited the enhanced electrochemical cell performance compared to that of the slurry cast electrodes containing LA133 binder. The prepared binder free electrodes exhibited excellent rate performance at the C-rate of up to 2 C.

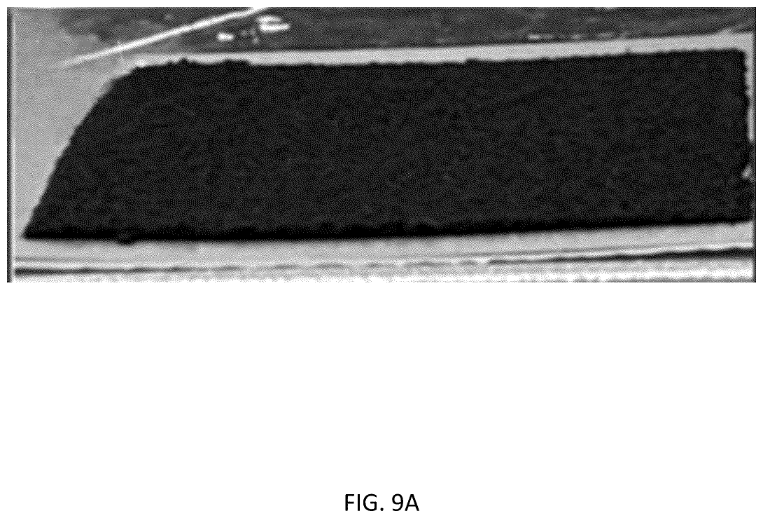

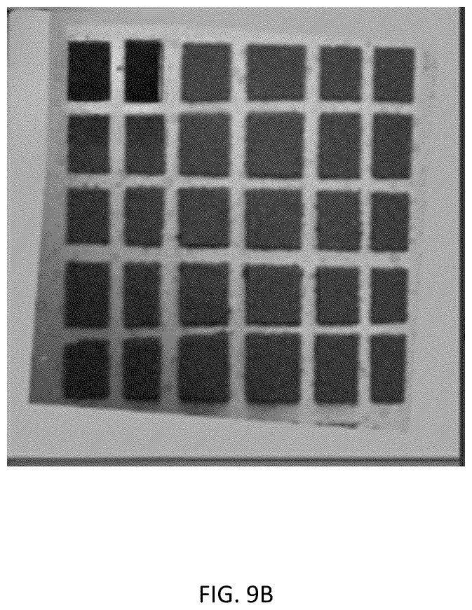

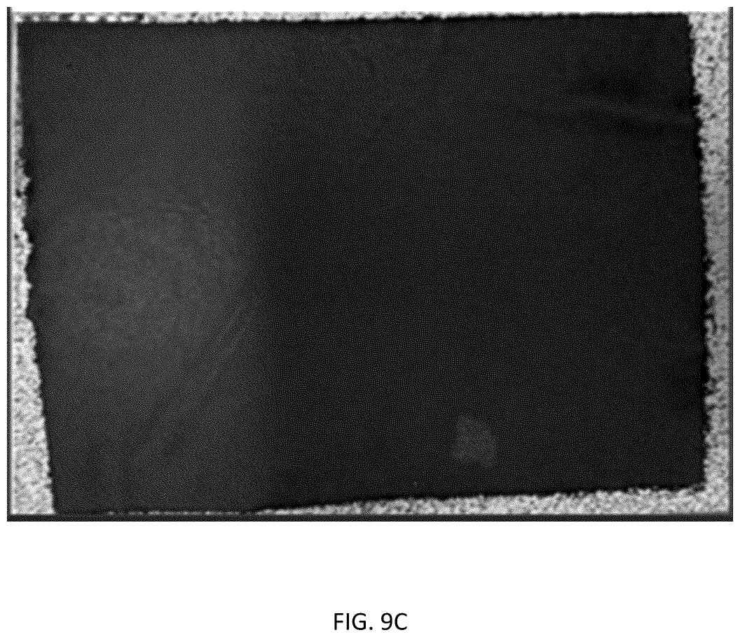

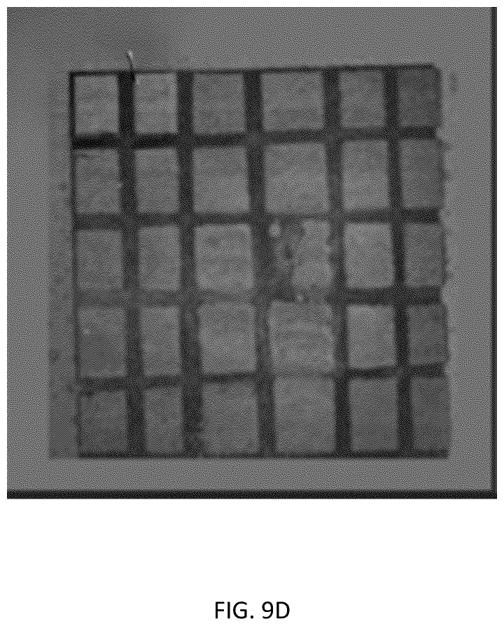

FIGS. 9A-9D show photos of cast dry powder beds and electrodes for electrode powders of different compositions containing a binder. A dry powder bed 110 of a composite consisting of lithium cobalt oxide (LCO), super P and PVDF (LCO: 93%, C: 3%, PVDF 4% w/w) was formed. FIG. 9A shows a planar dry powder bed 110, FIG. 9B shows a patterned dry powder bed 110. FIGS. 9C and 9D shows LCO electrodes prepared by heat-roll press 106. Here, the contemplated dry fabrication method was applied to lithium cobalt oxide (LCO) cathodes combined with polyvinylidene difluoride (PVDF) binder, producing both planar and patterned electrodes. The electrode formulation, consisting of 93% w/w LCO, 3% w/w carbon black, and 4% w/w PVDF binder, was prepared for electrode fabrication. These results confirm the contemplated method's ability to fabricate lithium-ion battery (LIB) electrodes containing polymeric binders.

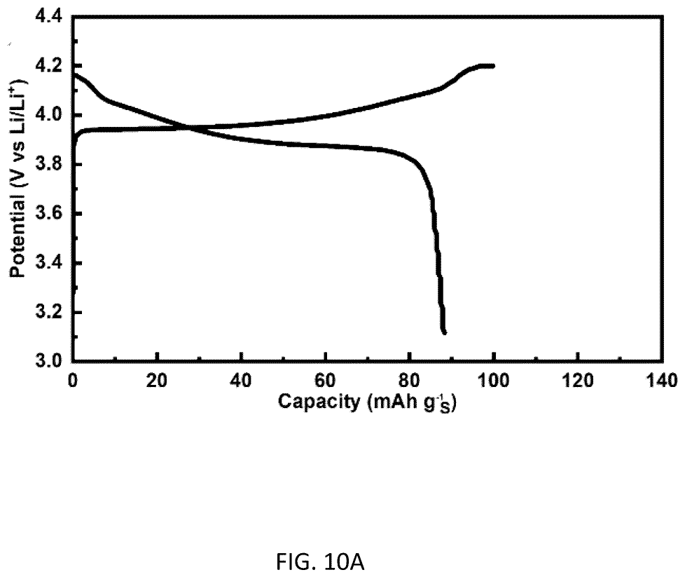

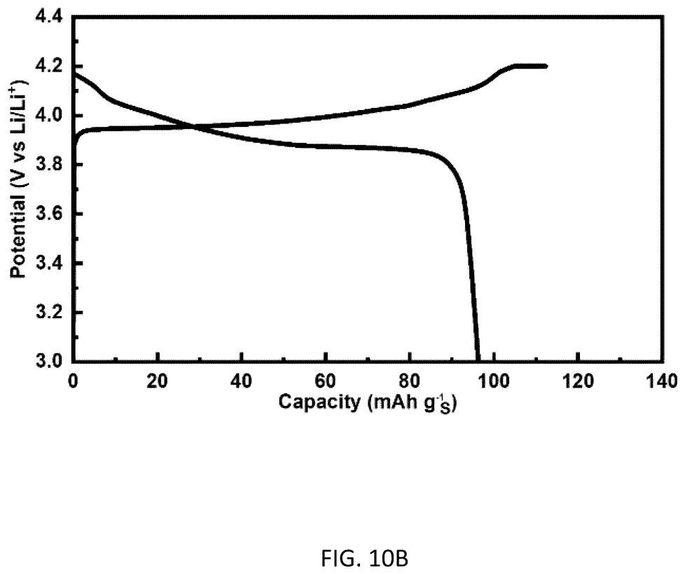

FIGS. 10A and 10B show voltage profiles of the planar and patterned LCO electrodes depicted in FIGS. 9C and 9D. Specifically, FIG. 10A is the planar LCO electrode shown in FIG. 9C, and FIG. 10B is the patterned LCO electrode shown in FIG. 9D. The electrolyte consists of 1.2 M lithium hexafluorophosphate in a mixture of ethylene carbonate and dimethyl carbonate (3:7 v/v). Testing was conducted in 2032 coin-type batteries. Although the electrode composition and process parameters were not optimized in this specific example, both planar and patterned LCO electrodes displayed characteristic voltage curves of an LCO cathode, underscoring the effectiveness of this process in manufacturing conventional LIB electrodes with polymer binders. Notably, the patterned electrodes demonstrated enhanced capacity under identical testing conditions.

It will be understood that implementations are not limited to the specific components disclosed herein, as virtually any components consistent with the intended operation of a method and/or system implementation for dry battery electrode manufacturing via direct powder bed formation and compression may be utilized. Accordingly, for example, although particular composite powders, powder dispensers, and compression devices may be disclosed, such components may comprise any shape, size, style, type, model, version, class, grade, measurement, concentration, material, weight, quantity, and/or the like consistent with the intended operation of a method and/or system implementation for dry battery electrode manufacturing via direct powder bed formation and compression may be used. In places where the description above refers to particular implementations of dry battery electrode manufacturing via direct powder bed formation and compression, it should be readily apparent that a number of modifications may be made without departing from the spirit thereof and that these implementations may be applied to other manufacturing methods.

What is claimed is:

1. A method for the solvent-free fabrication of a battery electrode, comprising:
forming a dry powder bed on top of a current collector that is metallic by dispensing a first electrode powder directly onto the current collector as a first layer, the first electrode powder being solvent-free and the dry powder bed comprising an active material;
compressing the dry powder bed and the current collector together using a heat-roll press, resulting in an electrode film adhered to the current collector that together form the battery electrode.

2. The method of claim 1:
wherein dispensing the first electrode powder comprises dispensing the first electrode powder using a first powder dispensing unit comprising a powder supply sieve suspended within an outer frame by a plurality of springs, the first electrode powder being placed upon the powder supply sieve, the powder supply sieve having a mesh size such that the powder supply sieve holds the first electrode powder when the powder supply sieve is motionless;
wherein dispensing the first electrode powder using the first powder dispensing unit comprises vibrating the powder supply sieve of the first powder dispensing unit such that the first electrode powder passes through the powder supply sieve while the current collector is positioned beneath the first powder dispensing unit.

3. The method of claim 2, wherein dispensing the first electrode powder using the first powder dispensing unit comprises vibrating the powder supply sieve of the first powder dispensing unit using a transducer.

4. The method of claim 1, wherein the first electrode powder comprises a binder.

5. The method of claim 1, wherein the first electrode powder is entirely composed of the active material.

6. The method of claim 1:
wherein forming the dry powder bed on top of the current collector further comprises dispensing a second electrode powder as a second layer directly onto the first layer composed of the first electrode powder;
wherein the electrode film is a multilayered electrode film.

7. The method of claim 6, wherein the first electrode powder and the second electrode powder have the same composition, the first electrode powder has a first particle size, and the second electrode powder has a second particle size that is different from the first particle size.

8. The method of claim 6, wherein the first electrode powder has a first composition and the second electrode powder has a second composition that is different from the first composition.

9. The method of claim 1:
wherein forming the dry powder bed further comprises dispensing additional electrode powder layers on top of the first layer such that the dry powder bed comprises a plurality of electrode powder layers, each electrode powder layer having a thickness;
wherein the plurality of electrode powder layers comprises a patterned powder layer with micro-patterned thickness variations.

10. The method of claim 9, wherein dispensing the patterned powder layer having the micro-patterned thickness variations comprises dispensing said electrode powder layer such that it falls through a patterning screen before becoming part of the dry powder bed.

11. The method of claim 1, further comprising:
recovering the first electrode powder collected on a window frame for reapplication;
wherein forming the dry powder bed comprises dispensing the first electrode powder such that the first electrode powder falls through the window frame before falling directly onto the current collector.

12. A method for the solvent-free fabrication of a battery electrode, comprising:
forming a dry powder bed on top of a current collector that is metallic by dispensing a first electrode powder directly onto the current collector as a first layer, then dispensing a second electrode powder as a second layer directly onto the first layer; and
compressing the dry powder bed and the current collector together using a heat-roll press, resulting in a multilayered electrode film adhered to the current collector that together form the battery electrode;
wherein the first electrode powder and the second electrode powder are both solvent-free and the dry powder bed comprising an active material and a binder.

13. The method of claim 12:
wherein dispensing the first electrode powder comprises dispensing the first electrode powder using a first powder dispensing unit comprising a powder supply sieve suspended within an outer frame by a plurality of springs, the first electrode powder being placed upon the powder supply sieve, the powder supply sieve having a mesh size such that the powder supply sieve holds the first electrode powder when the powder supply sieve is motionless;
wherein dispensing the first electrode powder using the first powder dispensing unit comprises vibrating the powder supply sieve of the first powder dispensing unit such that the first electrode powder passes through the powder supply sieve while the current collector is positioned beneath the first powder dispensing unit.

14. The method of claim 13, wherein dispensing the first electrode powder using the first powder dispensing unit comprises vibrating the powder supply sieve of the first powder dispensing unit using a transducer.

15. The method of claim 12:
wherein forming the dry powder bed further comprises dispensing additional electrode powder layers on top of the first layer such that the dry powder bed comprises a plurality of electrode powder layers, each electrode powder layer having a thickness;
wherein the plurality of electrode powder layers comprises a patterned powder layer with micro-patterned thickness variations.

16. The method of claim 15, wherein dispensing the patterned powder layer having the micro-patterned thickness variations comprises dispensing said electrode powder layer such that it falls through a patterning screen before becoming part of the dry powder bed.

17. A system for the solvent-free fabrication of a battery electrode, comprising:
a first powder dispensing unit positioned above a current collector that is metallic, the first powder dispensing unit configured to dispense a uniform first layer of a first electrode powder on top of the current collector, the first electrode powder being solvent-free and comprising an active material; and
a heat-roll press configured to receive the current collector and compress a dry powder bed and the current collector together to form an electrode film adhered to the current collector that together form the battery electrode, the dry powder bed having been formed on top of the current collector by the first powder dispensing unit dispensing the first electrode powder on top of the current collector as the first layer.

18. The system of claim 17, wherein:
the first powder dispensing unit comprises a powder supply sieve suspended within an outer frame by a plurality of springs,
wherein the first electrode powder is placed upon the powder supply sieve, the powder supply sieve having a mesh size such that the powder supply sieve holds the first electrode powder when the powder supply sieve is motionless;
wherein the first powder dispensing unit further comprises one of a transducer and a solenoid configured to vibrate the powder supply sieve and cause the first electrode powder to pass through the powder supply sieve and fall on to the current collector below the first powder dispensing unit.

19. The system of claim 17, further comprising a patterning screen positioned between the first powder dispensing unit and the current collector such that the first electrode powder uniformly dispensed by the first powder dispensing unit falls through the patterning screen before forming the first layer on top of the current collector, the first layer being a patterned powder layer with micro-patterned thickness variations.

20. The system of claim 17, further comprising a window frame positioned between the first powder dispensing unit and the current collector such that the first electrode powder dispensed by the first powder dispensing unit falls through the window frame before falling onto the current collector, wherein the first electrode powder collected on the window frame is recovered for reapplication.
